(19) United States
(12) Patent Application Publication
(10) Pub. No.: US 2020/0156260 A1
(43) Pub. Date: May 21, 2020

(54) Transfer Apparatus and Transfer System

(71) Applicant: SQUSE Inc., Kyoto-shi (JP)

(72) Inventors: Toru Takasaki, Kyoto-shi (JP); Yuya Wada, Kyoto-shi (JP); Yoshihiro Miyazaki, Kyoto-shi (JP); Yoshinobu Fukushima, Kyoto-shi (JP)

(21) Appl. No.: 16/596,272

(22) Filed: Oct. 8, 2019

(30) Foreign Application Priority Data
Nov. 19, 2018 (JP) 2018-216611

(51) Int. Cl. B25J 15/00; B65B 25/04; B25J 11/00; B25J 17/02; B25J 9/10

(52) U.S. Cl. CPC B25J 15/0009; B65B 25/046; B25J 9/1075; B25J 17/0283; B25J 11/0045

(57) ABSTRACT

A transfer apparatus includes a finger mechanism configured to grasp an outer circumferential face of an object, wherein the finger mechanism is equipped with a plurality of finger portions supported by a base portion, each of the finger portions includes a first bone member, a second bone member rotatably coupled to one end portion of the first bone member, and a pair of third bone members, each of which is rotatably coupled to the other end portion of the first bone member and the base portion, whereby a parallel link mechanism is formed between the first bone member and the base portion, and the finger mechanism transfers the grasped object to a containing box.

### CROSS-REFERENCE TO RELATED APPLICATIONS

This Nonprovisional application claims priority under 35 U.S.C. § 119(a) on Patent Application No. 2018-216611 filed in Japan on Nov. 19, 2018, the entire contents of which are hereby incorporated by reference.

### FIELD

The present invention relates to a transfer apparatus and a transfer system.

### BACKGROUND

Considerations and ingenuity required in the case that fruits/vegetables, such as apples, pears, mangoes, tomatoes and cucumbers, are transferred and box-packed are different from those required in the case that the other fruits/vegetables and the other objects are transferred and box-packed. In particular, in the case that peaches and tomatoes, the pericarp and flesh of which are easily damaged, are grasped and box-packed, careful attention and innovative ingenuity are required regardless whether such grasping and box packing work is performed by manpower or by various kinds of machines and apparatus.

A fruit/vegetable transfer apparatus automatically transport, grasp and box-pack fruits/vegetables using machines, various kinds of jigs, various kinds of means, various kinds of control means and control programs. Before the fruits/vegetables are box-packed in containing boxes, so-called fruit/vegetable sorting is automatically carried out in order to perform classification and grouping in which the fruits/vegetables are inspected to determine whether diseases, insect damage and flaws are present or not and the fruits/vegetables are measured in terms of color, gloss, shape, weight, etc. Furthermore, these sorted fruits/vegetables are grasped with, for example, a grasping means (robot hand) installed on a robot and are automatically box-packed in containing boxes, such as containers and trays. Hence, in order to inspect and measure the fruits/vegetables in terms of quality, shape, size, etc., the fruit/vegetable transfer apparatus requires a measuring means for measuring and recognizing the quality, shape, size, etc. The fruit/vegetable transfer apparatus also requires an image processing means and a grasping/releasing means configured so as not to impair the quality of the fruits/vegetables. The fruit/vegetable transfer apparatus further requires a means for recognizing the quantity of the fruits/vegetables having been stored and the predetermined positions of the fruits/vegetables stored in the containing box during box packing. Moreover, the fruit/vegetable transfer apparatus requires a control means capable of performing control so that the behaviors of the grasping means and the releasing means at the time when a fruit/vegetable is stored in a space of the containing box are made different from the behaviors thereof at the time when a fruit/vegetable is stored on a wall side of the containing box.

Japanese Laid-Open Patent Publication No. 2013-202728 has disclosed a harvesting hand apparatus for grasping circular and spherical fruits/vegetables, such as tomatoes, depending on the rigidity thereof. Japanese Laid-Open Patent Publication No. 2017-47481 has disclosed a food handling robot hand. This robot hand has three or more finger links that are disposed in parallel with the center axis thereof and equidistant from the center axis thereof and a synchronous rotation drive apparatus for enlarging and reducing the inscribed circle of the finger links. Japanese Laid-Open Patent Publication No. 2-180112 has disclosed a means for attaching protection caps to fruits, such as peaches, pears, apples, mangoes and melons. Japanese Laid-Open Patent Publication No. 2006-206193 has disclosed an agricultural product box-packing system capable of selecting the number of agricultural products to be picked up by suction at one time and capable of box-packing the selected agricultural products in a tray pack having an arrangement pattern designated for box packing.

However, with the conventional robot hands, it is difficult to stably grasp objects such as fruits and it is also difficult to perform box packing regardless of storage positions.

### SUMMARY

The present application has been made in consideration of these circumstances and is intended to provide a transfer apparatus and a transfer system capable of stably grasping objects and capable of box-packing (transferring) objects regardless of storage positions.

A transfer apparatus according to one aspect of the present application includes a finger mechanism configured to grasp an outer circumferential face of an object, wherein the finger mechanism is equipped with a plurality of finger portions supported by a base portion, each of the finger portions includes a first bone member, a second bone member rotatably coupled to one end portion of the first bone member, and a pair of third bone members, each of which is rotatably coupled to the other end portion of the first bone member and the base portion, whereby a parallel link mechanism is formed between the first bone member and the base portion, and the finger mechanism transfers the grasped object to a containing box.

A transfer system according to one aspect of the present application includes a containing box supplying apparatus configured to supply a containing box, a transfer apparatus configured to grasp an outer circumferential face of an object and to transfer the object to the containing box supplied from the containing box supplying apparatus, and a containing box carrying-out apparatus configured to carry out the containing box in which the objects are stored.

According to the present application, it is possible to grasp the object stably and box-pack (transfer) the object regardless of storage positions.

The above and further objects and features of the invention will more fully be apparent from the following detailed description with accompanying drawings.

### BRIEF DESCRIPTION OF DRAWINGS

FIG. 1 is a schematic three-dimensional view depicting a fruit/vegetable transfer apparatus according to the present invention;

FIG. 2 is a plan block diagram depicting the fruit/vegetable transfer apparatus further provided with additional apparatus other than those depicted in FIG. 1;

FIG. 3 is a view depicting a state in which, when an object (peach) is held (grasped) by the loading apparatus depicted in FIG. 1, the position and the placement direction of the object are inspected and measured;

FIGS. 4A to 4D are operation views depicting the flow of the objects between an inspection apparatus and the loading apparatus depicted in FIG. 2;

FIGS. 5A to 5G are operation views obtained by seeing FIGS. 4A to 4D from different viewpoints;

FIG. 6 is a detailed perspective view depicting a five-finger hand for use in the loading apparatus depicted in FIGS. 1 and 2;

FIGS. 7A to 7D depict states in which the five-finger hand, depicted in FIG. 6 and worn with a glove, grasps an object (peach) and is storing the object into a protection cap;

FIGS. 8A to 8E are views depicting the operation of the protection cap attaching apparatus depicted in FIGS. 1 and 2;

FIGS. 9A to 9C are schematic plan views depicting the containing box supplying apparatus depicted in FIGS. 1 and 2;

FIGS. 10A to 10C are schematic perspective views depicting a state in which a containing box is handled with the containing box supplying apparatus depicted in FIGS. 9A to 9C;

FIGS. 11A to 11F are views depicting the operation of the transfer apparatus depicted in FIGS. 1 and 2;

FIG. 12 is a perspective view depicting the hand portion of a robot hand for use in the transfer apparatus depicted in FIGS. 11A to 11F;

FIG. 13 is a view depicting the finger mechanism of the hand portion depicted in FIG. 12;

FIG. 14 is a schematic view depicting a state in which the finger mechanism of the robot hand depicted in FIGS. 12 and 13 grasps an object;

FIGS. 15A to 15E depict a transition state in which the robot hand depicted in FIGS. 12 to 14 receives an object from the expanding pawl portion;

FIGS. 16A and 16B are explanatory views illustrating the concept of rolling storage according to the present invention;

FIGS. 17A and 17B are explanatory views illustrating undesirable states that occur at the time when an object covered with the protection cap (cushion) is stored in a corner of the containing box using the robot hand depicted in FIG. 12;

FIGS. 18A and 18B are explanatory views illustrating the rolling storage according to the present invention devised to solve the problem depicted in FIGS. 17A and 17B;

FIG. 19 is an explanatory view illustrating that the behavior of an object to be stored by the rolling storage according to the present invention draws an epicycloid curve;

FIGS. 20A to 20D are storage arrangement views depicting examples in which the arrangement of objects to be stored in a containing box is made different depending on the quantity (qy) of objects per box;

FIG. 21 is an explanatory view illustrating a sequence for storing objects in a containing box.

### DESCRIPTION OF EMBODIMENTS

The present invention will be described below specifically on the basis of the drawings depicting an embodiment thereof.

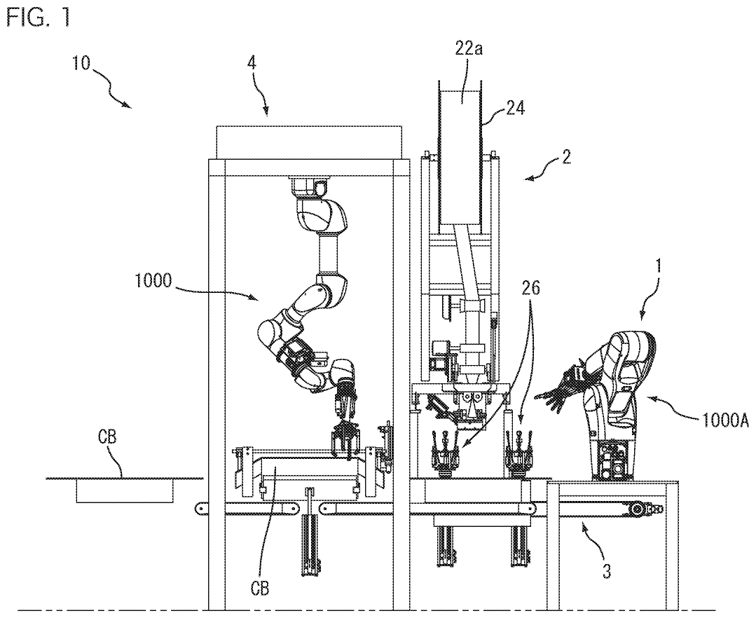

FIG. 1 is a schematic three-dimensional view depicting a fruit/vegetable transfer system 10. The fruit/vegetable transfer system 10 is used to automatically store spherical “fruits/vegetables” such as peaches, apples, pears, persimmons, mangoes, melons and tomatoes in a nearly rectangular parallelepiped containing box in a predetermined arrangement. In this embodiment, “fruit/vegetable” is a name referring to both fruit and vegetable. Among fruits/vegetables, for example, peaches, apples and tomatoes have a nearly spherical shape, but mangoes have a deformed spherical shape slightly different from a spherical shape. Furthermore, among persimmons, so-called compressed seedless persimmons have a flat square shape quite different from a spherical shape. “Fruit shape index” is known as a factor representing the shape of a fruit/vegetable. “Fruit shape index” represents the ratio (generally represented by vertical diameter/horizontal diameter) of the vertical diameter of a fruit (also referred to as “fruit height”) to the horizontal diameter of the fruit (also referred to as “fruit diameter”). It is also known that fruit shapes are classified into, for example, “spherical”, “long spherical” and “flat” shapes, according to this “fruit shape index”. In this embodiment, the shapes of fruits/vegetables having circular, conical and flat elliptical shapes are widely referred to as “spherical shape” regardless of the value of the “fruit shape index”.

Although the fruit/vegetable transfer system 10 is mainly suitable to the transfer of spherical fruits/vegetables, the system is suitable not only for the transfer of spherical fruits/vegetables but also to the transfer of deformed “objects” such as mangoes and persimmons having shapes deviating from a spherical shape. Furthermore, in these days, peaches, mangoes, melons, etc. are frequently box-packed in a state in which the outer circumferential faces thereof are protected with cushions (protection caps) made of, for example, foamed polyethylene. When the objects to which these protection caps are attached are grasped and when the grasped objects are stored in a containing box CB, the protection caps may be detached or deformed. Hence, grasping and box packing methods different from methods for handling objects to which the protection caps are not attached are required. The fruit/vegetable transfer system 10 according to this embodiment is suitable for the box packing of the objects to which the protection caps are attached. The details of the system will be described later.

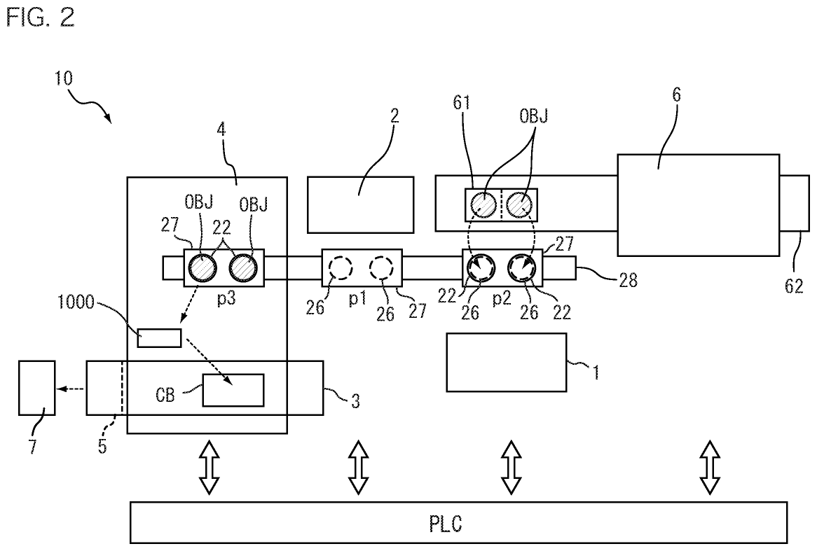

The fruit/vegetable transfer system 10 is equipped with a loading apparatus 1, a protection cap attaching apparatus 2, a containing box supplying apparatus 3, a transfer apparatus 4 and a containing box carrying-out apparatus 5 (see FIG. 2). Although objects to be box-packed are not depicted in FIG. 1, the objects are transported from the side of the loading apparatus 1 toward the containing box carrying-out apparatus 5. When the objects according to the present invention are transported to the predetermined position (grasping position) of the loading apparatus 1, the objects are grasped one by one by a robot hand 1000A and then they are stored (box-packed) in the containing box CB by a robot hand 1000 provided in the transfer apparatus 4 located at the latter stage. The details will be described later clearly.

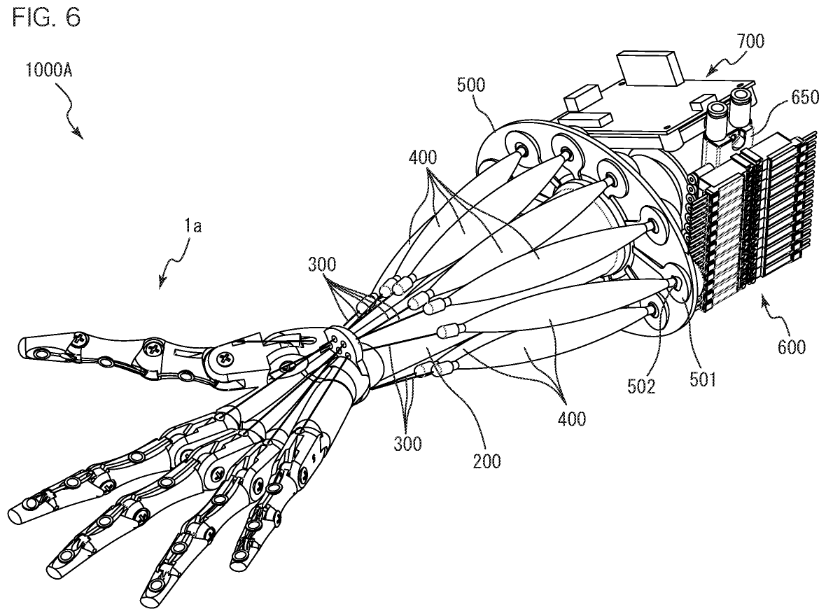

The loading apparatus 1 has, for example, the vertical multi-joint robot hand 1000A. The vertical multi-joint robot hand has, for example, freely rotatable six- or seven-axis joints, and a finger mechanism (hereafter referred to as a five-finger hand 1a) having five finger portions imitating, for example, the hand of a human being is mounted at the end portion, i.e., a so-called end effector, of the vertical multi-joint robot hand. The specific structure of the five-finger hand 1a will be described later (see FIG. 6). The five-finger hand 1a grasps a spherical fruit/vegetable (object), such as a peach and a tomato, transported to the loading apparatus 1 and then transports the object to the transfer apparatus 4 located at the later stage.

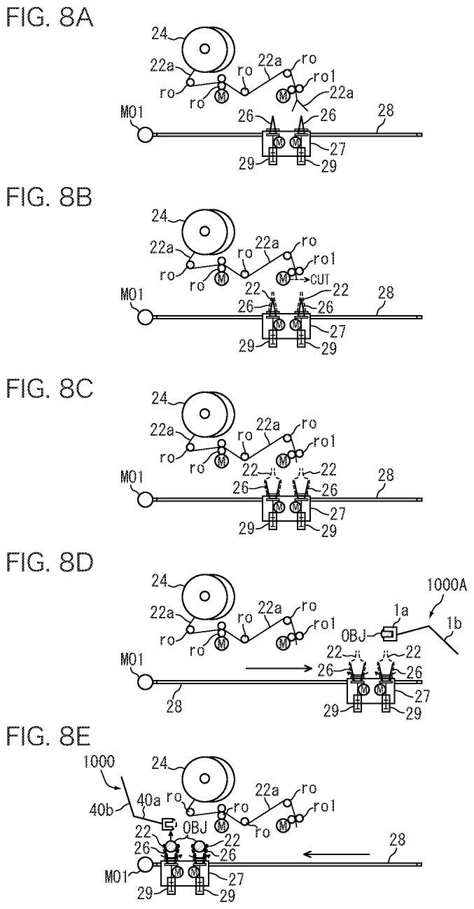

The protection cap attaching apparatus 2 is prepared to cover the outer circumferential face of an object with a protection cap 22 having been cut to a predetermined length (see FIGS. 8A to 8E). In the protection cap attaching apparatus 2, a long cylindrical protection cap member 22a is wound around a winding roller 24 in a flat shape. The protection cap attaching apparatus 2 is equipped with expanding pawl portions 26, each of which expands the flat protection cap member 22a to the extent that the protection cap member 22a can be attached to the circumference of a spherical object.

Although the protection cap attaching apparatus 2 is further equipped with, in addition to the expanding pawl portions 26, a cutter CUT (see FIGS. 8A to 8E) for cutting the protection cap member 22a to the predetermined length, a lifting mechanism for moving the expanding pawl portions 26 in the vertical direction, an opening/closing means for opening and closing the expanding pawl portions 26 and a turning means for turning the expanding pawl portions 26, no reference numerals are assigned to these means. When individual objects OBJ placed on the protection caps 22 are transported to the transfer apparatus 4 located at the latter stage, the turning means serve as a direction adjusting means for making adjustments so that the objects OBJ are directed in nearly identical directions. Since the directions of the individual objects are aligned, the operation of the robot hand at the time when a fruit/vegetable (object) is grasped with the robot hand and the operation at the time when the fruit/vegetable (object) is stored in the containing box CB by the robot hand can be performed as a routine. Consequently, the throughput of the box packing can be enhanced, and the space inside the containing box CB can be used effectively and can be filled with objects during the box packing.

A “predetermined portion” of an object (fruit/vegetable) is inserted by the loading apparatus 1 in a “predetermined direction” into the inside of the protection cap 22 that is attached to the expanding pawl portion 26 and cut to the predetermined length. The meanings of the “predetermined portion” and the “predetermined direction” will be described later. However, some objects are not covered with the protection caps 22. In such cases, the protection cap attaching apparatus 2 and the loading apparatus 1 are not essentially necessary. In the case that objects are not required to be covered with the protection caps 22, the objects are directly transported to the transfer apparatus 4.

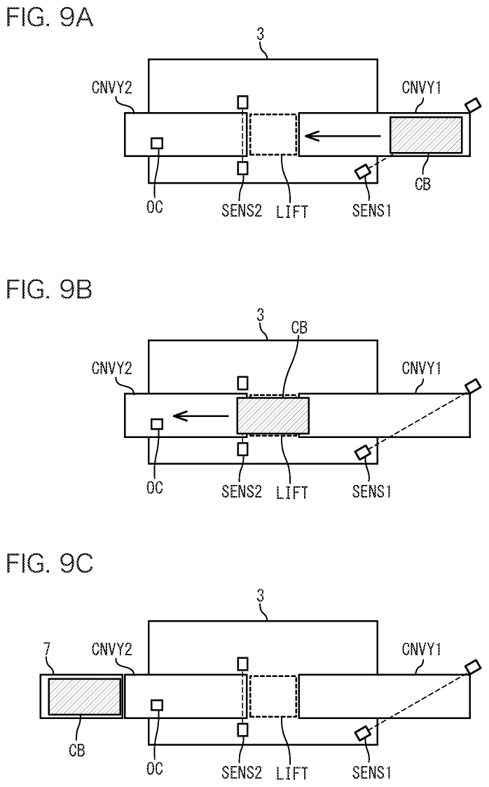

The containing box supplying apparatus 3 supplies the containing boxes CB, in which objects are box-packed, to the transfer apparatus 4 located at the later stage. The containing box supplying apparatus 3 is disposed on the lower side of the fruit/vegetable transfer system 10 and prepared, for example, so as to straddle the range from the nearly immediately lower portion of the protection cap attaching apparatus 2 to the containing box carrying-out apparatus 5. The size of the containing box CB supplied from the containing box supplying apparatus 3 can be selected on the basis of, for example, the vertical diameter and the horizontal diameter of the object, that is, the fruit shape index. The containing box CB for use in the present invention is, for example, a rectangular parallelepiped corrugated cardboard box. The containing box supplying apparatus 3 is prepared with, for example, a conveyor for transporting the containing box CB; a lifter LIFT (see FIGS. 9A to 9C) for elevating and lowering the containing box CB inside the containing box supplying apparatus 3 in the vertical direction; a stepping motor for controlling and driving the lifter LIFT; a containing box suppressing means for suppressing and fixing the containing box CB and its flaps; and air cylinders for driving flap suppressing means and the like.

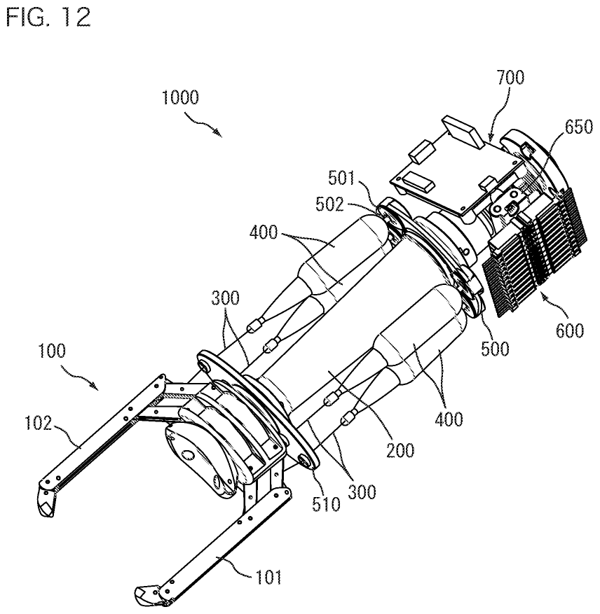

The transfer apparatus 4 stores the objects in the containing box CB supplied from the containing box supplying apparatus 3. The transfer apparatus 4 is equipped with the robot hand 1000 having a finger mechanism 100 (see FIG. 12) provided with, for example, two or four finger portions, the number of the finger portions being less than that of the finger portions of the five-finger hand 1a prepared in the loading apparatus 1. Generally speaking, as the number of the finger portions in the finger mechanism is larger, the grasping force thereof is improved although control becomes complicated. However, a robot hand with many finger portions is not always suitable in the case that such a robot hand stores a grasped object in the containing box CB. The reason is that, as the number of objects to be stored in the containing box CB becomes larger, the space in the containing box CB gradually becomes smaller, the degree of freedom of the finger mechanism mounted on the robot hand 1000 inside the containing box is limited and the robot hand cannot perform desired box packing, a longer time is required for box packing, and the throughput of the box packing becomes lower. Robot hand performing operation different from the operation of the five-finger hand 1a adopted in the loading apparatus 1 is adopted in the robot hand 1000. The details will be described later.

The containing box carrying-out apparatus 5 carries the containing box CB, in which a predetermined number of objects are stored by the transfer apparatus 4, out of the fruit/vegetable transfer system 10. The containing box carrying-out apparatus 5 has, for example, a conveyor, not depicted, in order to carry the containing box CB storing the objects out of the fruit/vegetable transfer system 10.

FIG. 2 is a block diagram depicting the fruit/vegetable transfer system 10, also depicting some apparatus in addition to the apparatus of the fruit/vegetable transfer system 10 depicted in FIG. 1. The fruit/vegetable transfer system 10 is additionally provided with an inspection apparatus 6 and an autonomous transport apparatus 7, not depicted in FIG. 1. Before an object OBJ (a peach or a tomato), for example, is transported by the loading apparatus 1 to the upstream side of the loading apparatus 1, that is, to the transfer apparatus 4 located at the later stage, the inspection apparatus 6 inspects the quality of fruit flesh, inspects the appearance, such as gloss and color, of the object OBJ and performs so-called physical measurements, such as the measurements of the fruit shape index (a value generally represented by vertical diameter/horizontal diameter) and the weight of the object. Various kinds of data and information obtained as the results of these inspections and measurements are transmitted to a PLC (Programmable Logic Controller). On the basis of such information, the PLC generates so-called sequence control programs for controlling various apparatus and various means according to predetermined procedures. Generally speaking, a robot, a robot hand and a finger mechanism mounted on the robot hand for use in a fruit/vegetable transfer system is controlled using a robot controller (CPU) prepared separately from the PLC in some cases. However, it should be understood that the PLC depicted in FIG. 2 includes this kind of CPU.

The fruit flesh quality inspection performed by the inspection apparatus 6 is carried out nondestructively, for example, by photographing an X-ray image of fruit flesh using an X-ray apparatus and by performing digital image processing for the photographed image. In the case that a peach is an object to be inspected, the peach is inspected whether peach fruit moth damage, for example, is present or not. Furthermore, inspections for detecting whether vermin damage is present or not in the object may be performed using a magnetic resonance imaging (MRI) apparatus that uses magnetism and radio waves instead of X-rays or using near-infrared light or the like. Moreover, physical measurements, such as the measurements of the shape, size and weight of the object can be performed, for example, by using an optical sensor having a light-emitting device and a light-receiving device. Although the measurements of, for example, the vertical diameter (fruit height) and the horizontal diameter (fruit diameter) of the peach, may be performed by the inspection apparatus 6, the measurements are preferably performed before the fruit is transported to the inspection apparatus 6. The reason is that the measurement values of the vertical diameter and the horizontal diameter of a fruit/vegetable are used as important parameters for selecting the shape and size of the containing box CB in which the fruit/vegetable is stored, for determining the grasping position of the fruit/vegetable and for determining the arrangement of the fruits/vegetables in the containing box CB. The throughput of box packing work can be raised by generating these data, parameters and the like beforehand.

After spherical fruits/vegetables (objects OBJ) have been subjected to at least one of the inspection and the measurement described above, the objects are placed on a chute 61, and the chute 61 is transported from the side of the inspection apparatus 6 to the side of the loading apparatus 1 along a chute track 62. The “predetermined portion” of the object OBJ is directed in the “predetermined direction” beforehand and carried out from the side of the inspection apparatus 6. The “predetermined portion” herein corresponds to a fruit peduncle portion or a fruit apex portion, for example, in the case that the object is a fruit/vegetable. Furthermore, for example, in the case that the object is a peach, a suture line having a shallow-groove shape and extending from the fruit peduncle portion to the fruit apex portion can be positioned as the “predetermined portion”. Alternatively, in the case that the length of the line segment extending from the fruit peduncle portion to the fruit apex portion is defined as the vertical diameter and that the length of the line segment orthogonal to the vertical diameter is defined as the horizontal diameter, the portion having the longest horizontal diameter may be positioned as the predetermined portion. Moreover, the “predetermined direction” indicates the direction in which the object is placed on the chute 61, that is to say, indicates whether the fruit peduncle portion or the fruit apex portion of the object is directed upward. What's more, in the case that a fruit/vegetable has a suture line and that the fruit/vegetable is directed in a predetermined direction with respect to the loading apparatus 1, this direction is also included in the “predetermined direction”. In either case, the “predetermined portion” and the “predetermined direction” may be determined referring to the shape, peduncle portion, fruit apex portion, vertical diameter (height) and horizontal diameter (width) of the object OBJ having been obtained using an optical measuring means.

A slider 27 slides on a rail 28 and reciprocates from the side of the loading apparatus 1 to the transfer apparatus 4. The objects OBJ transferred from the chute 61 by the loading apparatus 1 are placed on the slider 27. The expanding pawl portions 26 are fixed to the slider 27. The expanding pawl portions 26 first move to position p1 located in front of the protection cap attaching apparatus 2 in order that the protection caps 22 are attached to the expanding pawl portions 26. At this position, the protection caps 22 are attached to the expanding pawl portions 26. Next, the expanding pawl portions 26 (the slider 27) to which the protection caps 22 have been attached move to position p2 in front of the loading apparatus 1. At this position, the objects OBJ placed on the chute 61 are inserted into the protection caps 22 attached to the expanding pawl portions 26. Next, the objects OBJ placed on the expanding pawl portions 26 (the slider 27) by the loading apparatus 1 are transferred to position p3 located in the area of the transfer apparatus 4. The objects OBJ transferred to position p3 are stored by the robot hand 1000 in the containing box CB supplied from the containing box supplying apparatus 3. The containing box CB in which the objects OBJ are stored is carried out by the containing box carrying-out apparatus 5.

At the containing box carrying-out apparatus 5, the autonomous transport apparatus 7 stands by for the arrival of the containing box CB in which the objects OBJ are stored. The autonomous transport apparatus 7 autonomously or automatically moves the objects OBJ stored in the containing box CB by the transfer apparatus 4 to a predetermined position or a predetermined storage area without using a track or along a track. The autonomous transport apparatus 7 is prepared to enhance automation and to save manpower in physical distribution. However, the containing box CB in which the objects OBJ are stored is not required to be transported autonomously, but may be carried by manpower to the predetermined position as a matter of course.

More specific structures and operations of the loading apparatus 1, the protection cap attaching apparatus 2, the storage box supplying apparatus 3, the transfer apparatus 4, etc. depicted in FIGS. 2 and 1 will be described later.

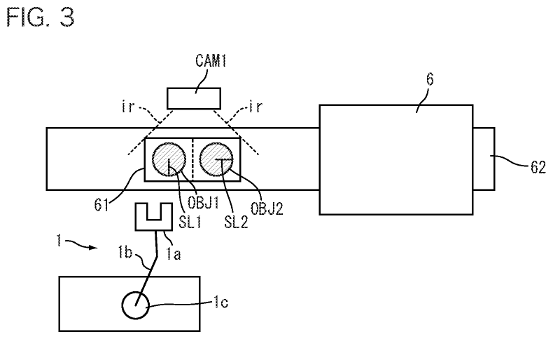

FIG. 3 is an explanatory view illustrating a state in which the position and the direction of the object OBJ to be grasped by the loading apparatus 1 are inspected and measured. FIG. 3 depicts the inspection apparatus 6, the chute track 62, a photographing device CAM1, the loading apparatus 1 and the objects OBJ placed on the chute 61. The object OBJ is generally carried out from the inspection apparatus 6 in a predetermined direction. Aligning the direction of the predetermined portion of the object OBJ to a predetermined direction is important in order to efficiently store the object OBJ in the containing box having a predetermined shape and a predetermined size. For example, in the case that the objects OBJ are peaches, the suture lines of the peaches are detected optically and the directions of the peaches are aligned on the basis of the suture lines. Consequently, box packing can be performed efficiently and box packing with beautiful appearance can be provided.

For convenience of explanation, FIG. 3 purposely depicts a state in which the directions of suture lines SL1 and SL2 are not identical but orthogonal to each other, that is to say, the directions deviate from the desired direction. In this state, the objects OBJ1 and OBJ2 are grasped with the loading apparatus 1 while the suture lines SL1 and SL2 are deviated from each other by nearly 90 degrees and then inserted into the protection caps 22 attached to the expanding pawl portions 26 (see FIG. 1). However, in the present invention, the directions of the suture lines SL1 and SL2 are photographed in a photographing range it by the photographing device CAM1, the information on the positions and inclinations thereof is transmitted to the PLC depicted in FIG. 2, and the rotation angles of the expanding pawl portions 26 are adjusted on the basis of the data and information. The rotation angle of the expanding pawl portion 26 is adjusted using a turning means (motor), not depicted in FIG. 3. With this configuration, even if the directions of the objects OBJ1 and OBJ2 are deviated from each other at the stage in which the objects are transferred to the expanding pawl portions 26 by the loading apparatus 1, the objects can be stored while being aligned to the predetermined direction at the time of box packing. In the case that a fruit/vegetable has no suture line or the existence of the suture line is indistinct, and for example, in the case that the object OBJ is a fruit, the direction of the object may be detected by detecting the fruit apex portion and the fruit peduncle portion the fruit or by detecting and measuring the vertical diameter and the horizontal diameter of the fruit. In FIG. 3, the loading apparatus 1 is composed of the five-finger hand 1a, an arm 1b and a base 1c.

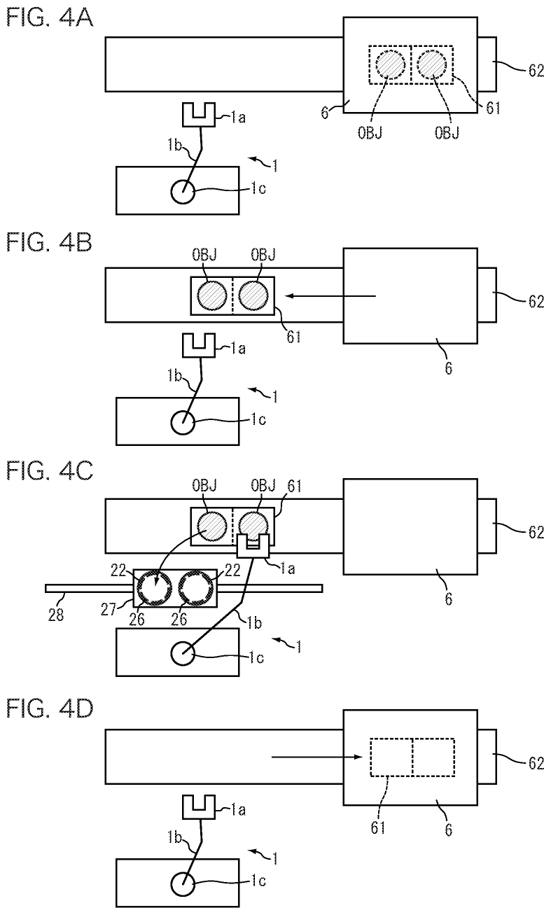

FIGS. 4A to 4D schematically depict the transfer of the objects OBJ between the inspection apparatus 6 and the loading apparatus 1 while particularly paying attention to the movement of the chute 61. The same components as those depicted in FIG. 3 are designated by the same reference numerals and signs.

FIG. 4A depicts a state in which the objects OBJ are being inspected or measured or the inspection and the measurement have just ended, the objects OBJ are placed on the chute 61 that slides along the chute track 62, and the objects OBJ are positioned in the inspection apparatus 6 or in the vicinity thereof. At this time, the five-finger hand 1a and the arm 1b of the loading apparatus 1 remain coupled to the base 1c while maintaining their initial postures and are not approaching the objects OBJ at all.

FIG. 4B depicts a state in which the quality inspection and physical measurements of the objects OBJ have ended, the objects OBJ have been placed on the chute 61, the chute 61 have slid along the chute track 62, and the objects OBJ stand by at the grasping position of the loading apparatus 1. Also at this time, the five-finger hand 1a and the arm 1b stand while maintaining their initial postures and are not approaching the objects OBJ at all.

FIG. 4C depicts a state in which the slider 27 of the protection cap attaching apparatus 2 has slid along the rail 28 and has moved to the vicinity of the chute 61. At this time, the expanding pawl portions 26 fixed to the slider 27 have also moved to vicinity of the chute 61. Furthermore, FIG. 4C depicts a state in which the arm 1b has extended to the side of the chute 61 in order to grasp the object OBJ placed on the chute 61, and the five-finger hand 1a is placing the object on the expanding pawl portion 26 of the protection cap attaching apparatus 2.

FIG. 4D depicts a state in which the objects OBJ have been placed on the sides of the expanding pawl portions 26 depicted in FIG. 4C, the chute 61 has slid along the chute track 62 and has returned to the side of the inspection apparatus 6, thereby standing by for the placement of the next objects OBJ that will be carried out from the side of the inspection apparatus 6 to the side of the loading apparatus 1. At this time, the objects OBJ placed on the expanding pawl portions 26 of the protection cap attaching apparatus 2 have moved to the side of the transfer apparatus 4 away from the display range of FIG. 4D. Furthermore, at this time, the arm 1b and the five-finger hand 1a have returned to their initial standby states.

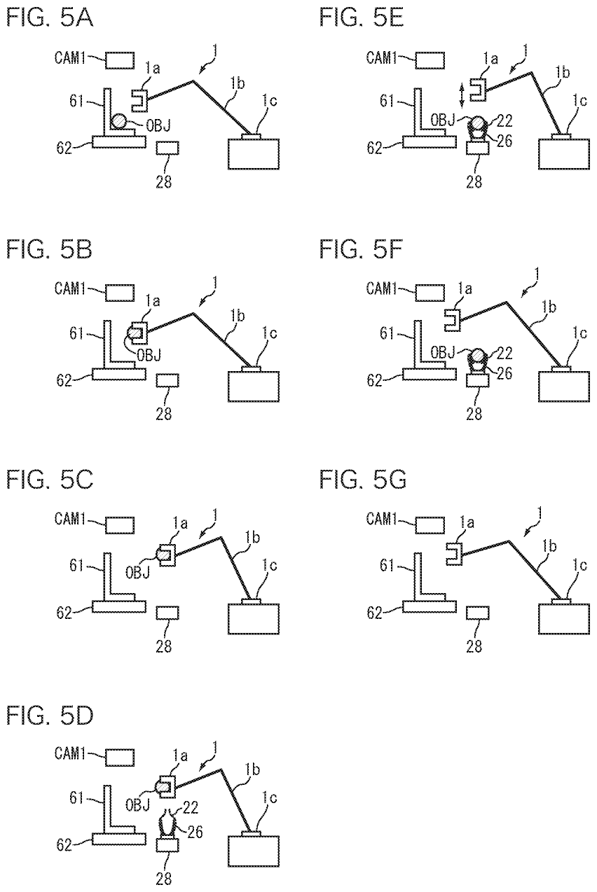

Like FIGS. 4A to 4D, FIGS. 5A to 5G depict the operations of the chute 61, the loading apparatus 1 and the protection cap attaching apparatus 2 and the displacement of the object OBJ. Although attention is paid particularly to the displacement of the chute 61 in the above-mentioned FIGS. 4A to 4D, attention is paid particularly to the movement of the expanding pawl portion 26 and the displacement of the object OBJ in FIGS. 5A to 5G. The operations of the arm 1b and the five-finger hand 1a of the loading apparatus 1 follow the operations of the protection cap attaching apparatus 2 and the object OBJ. The photographing device CAM1 is provided in order to detect the position and direction of the object OBJ. In FIGS. 5A to 5G, the same components as those depicted in FIGS. 4A to 4D are designated by the same reference numerals and signs.

FIG. 5A depicts a state in which the object OBJ is placed on the chute 61, the arm 1b has extended from the base 1c, and the five-finger hand 1a is approaching the object OBJ to grasp the object. At this time, the protection cap attaching apparatus 2, in particular, the expanding pawl portion 26 that receives the protection cap 22 and expands the received protection cap 22 has not yet moved to the grasping position. Hence, the expanding pawl portion 26 is not depicted in the display range of FIG. 5A, but only the rail 28 on which the expanding pawl portion 26 slides is depicted. The slider 27 that moves by sliding on the rail 28 stands by on the side of the loading apparatus 1. The photographing device CAM1 for detecting the existence and position of the object OBJ is provided above the chute 61.

FIG. 5B depicts a state in which the five-finger hand 1a has grasped the object OBJ placed on the chute 61 and is moving away from the chute 61. At this time, the expanding pawl portion 26 has not yet moved to the grasping position, that is, the position at which the chute 61 is opposed to the loading apparatus 1. Like FIG. 5A, FIG. 5B depicts only the rail 28. Hence, the slider 27 and the expanding pawl portion 26 fixed thereto are not depicted.

FIG. 5C depicts a state in which the five-finger hand 1a has grasped the object OBJ placed on the chute 61 and has moved to a position above the rail 28. In this state, the slider 27 (the expanding pawl portion 26) has not yet arrived at the grasping position of the five-finger hand 1a.

FIG. 5D depicts a state in which the chute 61 and the expanding pawl portion 26 have moved to the grasping position, that is, the area in which the loading apparatus 1 can turn, also depicts a state just before the object OBJ is placed on the expanding pawl portion 26. At this time, the expanding pawl portion 26 having, for example, six pawls, expands the protection cap 22 in the lateral direction so that the object OBJ is smoothly inserted into the protection cap 22.

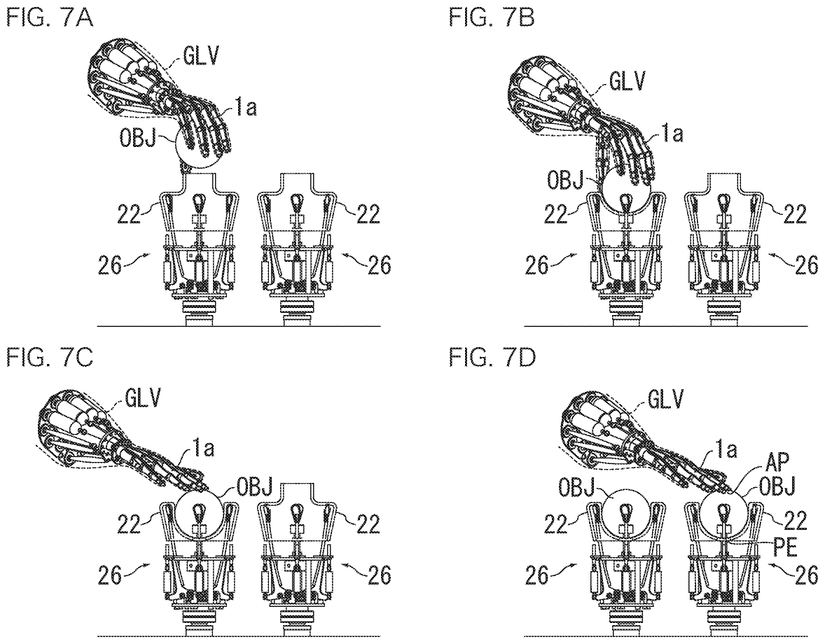

FIG. 5E depicts a state in which the object OBJ is inserted into the inside of the protection cap 22 prepared in the expanding pawl portion 26. At this time, the five-finger hand 1a applies a slight force to part of the spherical face of the object, for example, a peach (object OBJ) on which its suture line appears so that the object OBJ reaches the bottom portion of the protection cap 22. This eliminates a state in which the peach is suspended inside the protection cap 22. The state in which the five-finger hand 1a slightly pushes the peach into the protection cap 22 is depicted in FIGS. 7C and 7D described later. After inserting the object OBJ into the protection cap 22 attached to the expanding pawl portion 26, the five-finger hand 1a moves upward to the extent that the five-finger hand 1a does not hinder the movement of the slider 27.

FIG. 5F depicts a state in which, after having moved above the expanding pawl portion 26, the five-finger hand 1a moves to the vicinity of the chute 61, that is, the origin position of the grasping operation. At this time, the object OBJ inserted into the protection cap 22 prepared in the expanding pawl portion 26 remains placed at the position where the chute 61 is opposed to the loading apparatus 1.

FIG. 5G depicts a state in which, after having moved above the expanding pawl portion 26, the five-finger hand 1a has stopped at the vicinity of the chute 61, that is, the origin position of the grasping operation, and the object OBJ inserted into the protection cap 22 prepared in the expanding pawl portion 26 is placed on the slider 27 and moved to the side of the transfer apparatus 4. The photographing device CAM1 depicted in FIGS. 5A to 5G is the same as the photographing device CAM1 depicted in FIG. 3 and is used to photograph the position and direction in which the object OBJ is placed at the time when the loading apparatus 1 grasps the object OBJ.

FIG. 6 is an external view depicting an outline configuration of the robot hand 1000A for use in the loading apparatus 1. The robot hand 1000A according to this embodiment is equipped with the five-finger hand 1a, an antebrachial bone 200, tendons 300, artificial muscles 400, solenoid valves 600 and a control board 700. The finger portions in the five-finger hand 1a are configured so as to extend or flex depending on the tensions of the tendons 300 that are expanded or contracted by the artificial muscles 400. In this embodiment, as one of features, joint angles and forces are autonomously controlled by performing antagonistic control of two kinds of tendons 300 in order to achieve control (compliance control) for the form of grasping, holding force, the flexibility of finger joints, etc.

The artificial muscles 400 are disposed around the antebrachial bone 200. The antebrachial bone 200 corresponds to the antebrachial bone of a human being and is a member corresponding to the portion ranging from the wrist joint to the arm joint. The artificial muscle 400 is, for example, a Mckibben air-driven actuator, and the contraction degree of the muscle is controlled by the air supplied from a manifold 650 controlled by the opening/closing operations of the solenoid valve 600. In other words, in the case that air is supplied to the inside of the artificial muscle 400, the artificial muscle 400 expands in its lateral direction and shrinks in its longitudinal direction, whereby the muscle contracts. Conversely, in the case that air is released from the inside of the artificial muscle 400, the artificial muscle 400 shrinks in its lateral direction and extends in its longitudinal direction, whereby the muscle relaxes.

The solenoid valve 600 is controlled using a CPU, not depicted, mounted on the control board 700. The CPU transmits and receives various kinds of instruction signals and control signals between the CPU and the PLC depicted in FIG. 2. In addition to the CPU, an input side connector for use in various kinds of interfaces communicating with the CPU; an output side connector; coil drivers for driving the coils of the solenoid valves 600; and various kinds of electronic devices including operational amplifiers, comparators, transistors, diodes and resistors for processing various kinds of signals, voltages and currents may be mounted on the control board 700.

The distal side end portion of the artificial muscle 400 is connected to the tendon 300, and the proximal side end portion thereof is connected to a universal joint 502. The universal joint 502 is configured so as to freely slide inside a rib 501 provided in a demarcated region of a flange 500. The tendon 300 connected to the artificial muscle 400 is lengthened by the contraction of the artificial muscle 400 and is shortened by the relaxation of the artificial muscle 400.

In this embodiment, although the Mckibben air-driven actuator is used as the artificial muscle 400, a system for winding the tendon 300 using a motor and a pulley may be adopted instead of the air-driven actuator. Furthermore, it may be possible to adopt a system for directly expanding and contracting the tendon 300 using a linear motor or a system for expanding and contracting the tendon 300 using BioMetal formed of a fibrous actuator that is expanded and contracted by the flow of electric current.

FIGS. 7A to 7D depict states in which the five-finger hand 1a, depicted in FIG. 6 and worn with a glove GLV, grasps a peach serving as one of the objects OBJ and is inserting the object into the protection cap 22 that has been expanded by the opening/closing operations of the expanding pawl portion 26. The glove GLV is formed so as to match the size and shape of the five-finger hand 1a and is made of, for example, silicone rubber, nitrile rubber or natural rubber. However, the material of the glove GLV is not required to be rubber but may be a synthetic resin, such as polyvinyl chloride. Since the five-finger hand 1a is worn with the glove GLV, the five-finger hand 1a is prevented from being abraded mechanically, the force for grasping the object OBJ is increased, the quality of the object is not deteriorated and hygienic safety can be ensured.

FIG. 7A depicts a state in which the five-finger hand 1a is inserting a first peach (object OBJ) into the mesh-shaped protection cap 22 attached to one of the two expanding pawl portions 26 prepared in the protection cap attaching apparatus 2. On the right side of the expanding pawl portion 26, the other expanding pawl portion 26 to which the protection cap 22 has already been attached stands by for the next processing. In this state, the protection cap 22 is expanded in the lateral direction at the portion making contact with the expanding pawl portion 26 but is slightly shrunk at the portion away from the expanding pawl portion 26.

FIG. 7B depicts a state immediately after the state depicted in FIG. 7A, more specifically, a state in which the peach (object OBJ) is being inserted into the protection cap 22 having been expanded by the expanding pawl portion 26. At this time, the portion of the protection cap 22 having been slightly shrunk is folded back inward, whereby the protection cap 22 is formed into a double structure.

FIG. 7C depicts a state in which, after the peach is inserted into the protection cap 22, the upper portion of the object is slightly pushed with a portion of the five-finger hand 1a, for example, at least one of the central three finger portions (index finger, middle finger and ring finger) thereof, toward the lower portion of the protection cap 22. However, instead of the finger portions, the palm of the five-finger hand 1a facing the object may be used as the portion for pushing the object. In the case that the peach is merely inserted into the protection cap 22, the peach is not necessarily accommodated in a stable state at the bottom and side portions of the protection cap 22. The reason is that the peach may be suspended inside the protection cap 22 and the expanding pawl portion 26 by the elasticity of the protection cap 22. If the peach is transported toward the transfer apparatus 4 in this state, a certain amount of impact may be applied to the peach (object OBJ), the peach may be deformed, and the pericarp or flesh of thereof may be damaged. Even if the peach is not deformed or its flesh and the like are not damaged, a problem may be caused during desired box packing work because of the difference in height occurring at the time when the peach is grasped and lifted from the expanding pawl portion 26 at the transfer apparatus 4 located at the later stage. Slightly pushing the peach with the portion of the five-finger hand 1a is effective in solving this kind of problem. This slight pushing is performed after the first peach is placed (see FIG. 7B) and also performed after the second peach is placed.

FIG. 7D depicts a state in which, after the second peach is inserted into the protection cap 22, the upper portion of the object OBJ is slightly pushed with at least one of the central three finger portions (index finger, middle finger and ring finger) of the five-finger hand 1a toward the lower portion of the protection cap 22, in the same way as the first peach was pushed. In the embodiment according to the present invention, the fruit apex AP of a fruit/vegetable corresponds to the upper portion of the object OBJ and the fruit peduncle (fruit stem) portion PE corresponds to the lower portion thereof. Whether the fruit apex portion of a fruit/vegetable or the fruit peduncle (fruit stem) portion thereof is defined as the upper portion to be grasped may be determined appropriately depending on the kind, vertical diameter and horizontal diameter of the fruit/vegetable. For example, in the case of an apple or a pear, contrary to the case of the peach, the fruit is box-packed so that the fruit peduncle (fruit stem) portion thereof is defined as the upper portion. In either case, a fruit/vegetable is generally box-packed in a containing box in the direction in which the fruit/vegetable is grasped with the five-finger hand 1a.

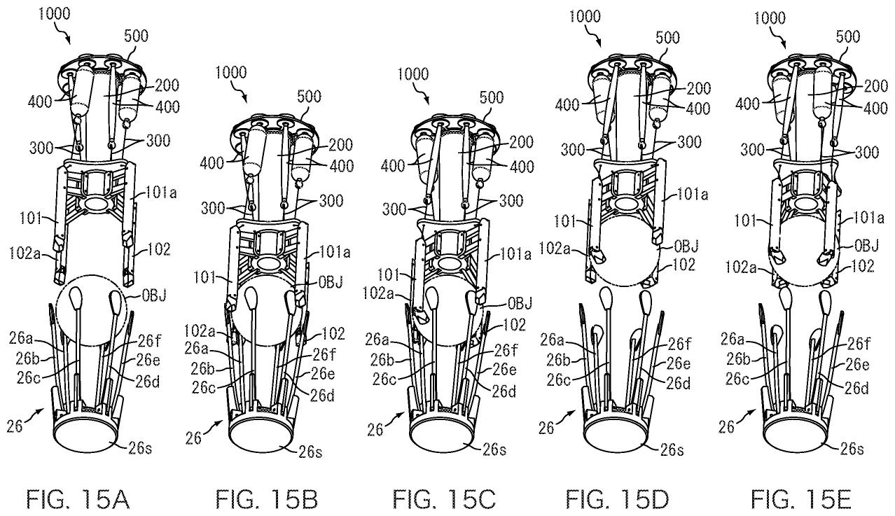

FIGS. 8A to 8E are views depicting the operation of the protection cap attaching apparatus 2. The components depicted in FIGS. 8A to 8E include the protection cap member 22a, the winding roller 24, the expanding pawl portions 26, the slider 27, the rail 28, rollers ro and ro1, the five-finger hand 1a, the arm 1b, the robot hand 1000, the hand 40a and the arm 40b of the robot hand 1000 and the object OBJ. The structure of the expanding pawl portion 26 is not depicted in FIGS. 8A to 8E but depicted in FIGS. 15A to 15E described later.

Following the cutting of the protection cap member 22a, the rollers ro and ro1 carry out a predetermined length of the protection cap member 22a from the winding roller 24 toward the expanding pawl portions 26 and guides the protection cap member 22a in a predetermined direction. The expanding pawl portions 26 are controlled and moved on the rail 28 in the left-right direction by a motor M01.

FIG. 8A depicts a state immediately before the protection cap member 22a is attached to each of the two expanding pawl portions 26 and 26. The protection cap member 22a is attached to each of the expanding pawl portions 26 and 26 by the rising of the expanding pawl portion 26 toward the roller ro1. The up-down movement of the expanding pawl portions 26 is controlled by the lifting mechanisms 29 installed in the slider 27.

In FIG. 8A, the flat protection cap member 22a wound around the winding roller 24 is guided to the upper portion of the expanding pawl portion 26 by the plurality of rollers ro and then opened by the roller ro1 provided in the vicinity of the expanding pawl portion 26.

FIG. 8B depicts a state in which the protection cap member 22a is cut by the cutting blade CUT and the protection cap 22 is attached to the expanding pawl portion 26. More specifically, the protection cap 22 is made by cutting the protection cap member 22a to a predetermined length using the cutting blade CUT. At this time, since the six pawls (see FIGS. 15A to 15E described later) constituting the expanding pawl portion 26 remain closed, the protection cap 22 is not expanded.

FIG. 8C depicts a state in which the six pawls prepared in the expanding pawl portion 26 and having been closed are opened, thereby expanding the protection cap 22 to the extent that a spherical object can be inserted into the protection cap 22. However, since the mechanism for expanding the expanding pawl portion 26 is known, the detailed explanation thereof is omitted.

FIG. 8D depicts a state in which, after the slider 27 is slid on the rail 28 and moved to the grasping position of the five-finger hand 1a while the state of the expanding pawl portion 26 depicted in FIG. 8C is maintained, the five-finger hand 1a is inserting each of the two objects OBJ into the protection cap 22. The five-finger hand 1a of the loading apparatus 1 transfers each object OBJ to each of the two expanding pawl portions 26.

FIG. 8E depicts a state in which, while the two objects OBJ inserted in the protection caps 22 having been attached to the expanding pawl portions 26 remain placed on the slider 27, the objects OBJ are moved to the side of the robot hand 1000 prepared in the transfer apparatus 4, and each of the objects OBJ is in a state before being grasped with the hand 40a and stored in the containing box CB, not depicted. In order to take out the object OBJ from the protection cap 22 enclosed with the six pawls constituting the expanding pawl portion 26, the tip end portion of the hand 40a enters the protection cap 22 deeper beyond the tip end portions of the six pawls and grasps the object OBJ. At this time, the hand 40a must be prevented from colliding with the six pawls. An example of a configuration for preventing this problem will be explained referring to FIGS. 15A to 15E described later.

FIGS. 9A to 9C are schematic plan views depicting the containing box supplying apparatus 3. The containing box supplying apparatus 3 prepares the containing box CB (for example, a corrugated cardboard box) for storing the objects OBJ and supplies the containing box to the transfer apparatus 4 located at the later stage. As depicted in FIG. 1, the containing box supplying apparatus 3 is prepared so as to straddle the range from the lower portion of the protection cap attaching apparatus 2 to the lower portion of the containing box carrying-out apparatus 5. As depicted in FIGS. 9A to 9C, the containing box supplying apparatus 3 has a first conveyor CNVY1, a second conveyor CNVY2 and the lifter LIFT. When the containing box CB is supplied from the first conveyor CNVY1 to the lifter LIFT, the containing box CB is fixed at a predetermined position by the lifter LIFT, and the objects OBJ are stored in the containing box CB. After the work for storing the objects is completed, the box-packed objects OBJ are carried out from the containing box carrying-out apparatus 5 depicted in FIG. 1 via the second conveyor CNVY2. The second conveyor CNVY2 is a part of the containing box supplying apparatus 3 and is also a part of the containing box carrying-out apparatus 5.

A sensor SENS1 detects whether the containing box CB is placed on the first conveyor CNVY1. A sensor SENS2 detects whether the containing box CB has arrived at the lifter LIFT. When it can be confirmed by the sensor SENS2 that the containing box CB has arrived at the lifter LIFT, the operation of the first conveyor CNVY1 is stopped by a control means, not depicted. An optical communication device OC performs optical communication with the autonomous transport apparatus 7 and transmits, at the time of the completion of the box packing, a signal indicating that the box packing work is completed. The optical communication device OC is provided with well-known optical devices, such as LEDs and lasers, and an optical IC in which these optical devices are integrated.

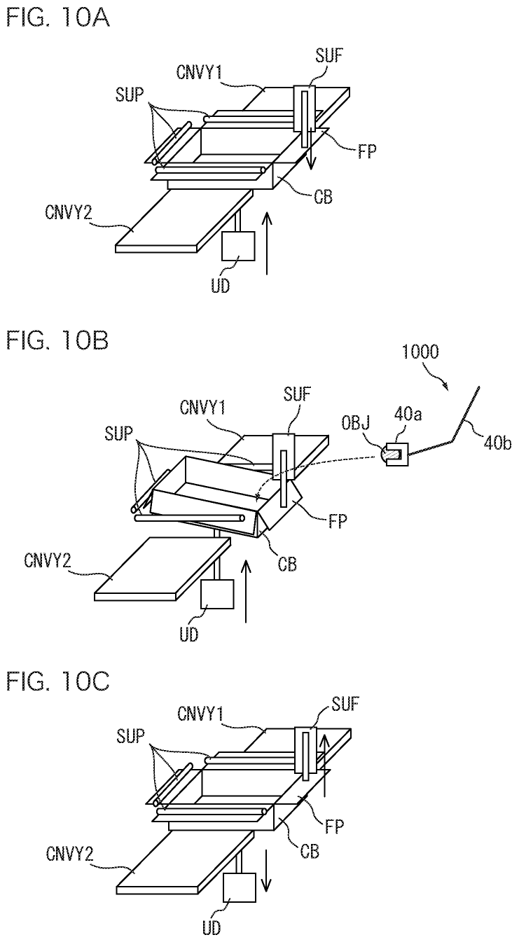

FIGS. 10A to 10C are schematic perspective views depicting a state in which the containing box CB is handled with the lifter LIFT of the containing box supplying apparatus 3. The containing box CB is, for example, a rectangular parallelepiped corrugated cardboard box. The same components as those depicted in FIGS. 9A to 9C are designated by the same reference numerals and signs.

FIG. 10A depicts the portions of the containing box CB at the time when the containing box CB is placed on the lifter LIFT depicted in FIG. 9B, and also depicts, in addition to the containing box CB, containing box suppressors SUP for fixing the containing box CB at a predetermined position, the flaps FP of the containing box CB and a flap suppressor SUF for suppressing a flap of the containing box CB. In FIG. 10A, the containing box CB is placed on a lifting mechanism UD capable of moving the containing box CB in the up-down direction. The position of the lifting mechanism UD is adjusted in several steps, for example, three steps, by, for example, a stepping motor depending on how the containing box CB is handled. These suppressors SUP are driven, for example, by air cylinders. The flap (lid) FP of the containing box CB is suppressed by the flap suppressor SUF.

FIG. 10B depicts a state in which the object OBJ is grasped with the robot hand 1000 and stored in the containing box CB. At the time of the storage, the containing box CB is slightly inclined in order to support the storage of the object OBJ. At this time, the lifting mechanism UD is fixed at a predetermined position. In FIG. 10B, the same components as those depicted in FIG. 10A are designated by the same reference numerals and signs.

FIG. 10C depicts a state in which the box packing work for the objects OBJ by the robot hand 1000 is completed and the containing box CB is carried out. At this time, the lifting mechanism UD moves the containing box CB downward. Furthermore, the flap suppressor SUF moves away from the flap FP and the containing box suppressors SUP also move away from the containing box CB, and the lifting mechanism UD moves downward and then stands by for the supply of the next containing box CB.

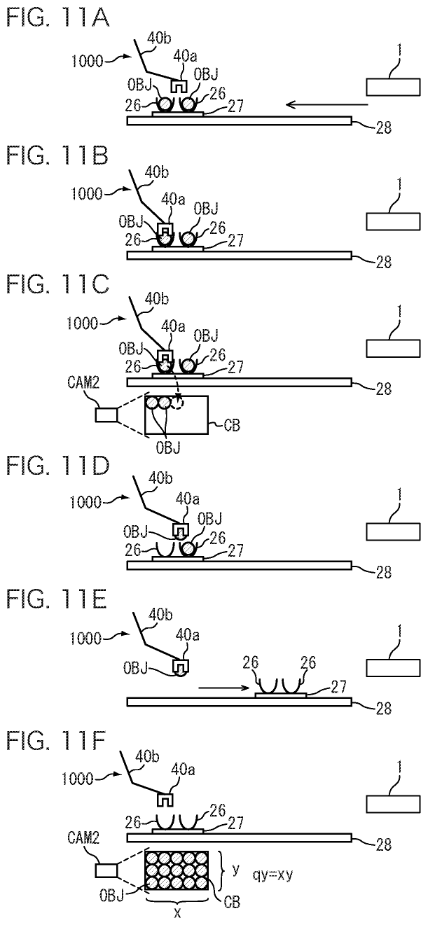

FIGS. 11A to 11F are views depicting the flow of the operation of the transfer apparatus 4. FIGS. 11A to 11F depict a series of flows from the grasping of the objects OBJ placed on the slider 27 by the loading apparatus 1 using the robot hand 1000 serving as a part of the transfer apparatus 4 to the box packing of the objects OBJ in the containing box CB. The slider 27 moves by reciprocating between the loading apparatus 1 and the transfer apparatus 4 on the rail 28 as described above. FIGS. 11A to 11F depict the robot hand 1000 and also depict the hand 40a and the arm 40b constituting the robot hand 1000. Furthermore, FIGS. 11A to 11F depict the expanding pawl portions 26, a photographing device CAM2, the containing box CB and the objects OBJ. Although the objects OBJ are covered with the protection caps 22, the protection caps 22 are not depicted for the convenience of explanation and drawing.

FIG. 11A depicts a state in which the expanding pawl portions 26, which are fixed to the slider 27 and on which the objects OBJ are placed, are moving from the side of the loading apparatus 1 to the grasping position of the robot hand 1000. At this time, the robot hand 1000 does not approach the objects OBJ at all but remains standing by at its standby position.

FIG. 11B depicts the operation of the robot hand 1000 immediately after the state depicted in FIG. 11A. FIG. 11B depicts a state in which the hand 40a and the arm 40b of the robot hand 1000 have lowered to the grasping position of the object OBJ and then the robot hand 1000 is grasping the object OBJ. The grasped objects OBJ are stored in the containing box CB one by one (see FIGS. 11C and 11F).

FIG. 11C depicts a state in which several objects OBJ have been stored in the containing box CB and this storage work is being performed continuously. At this time, the quantity qn of the objects OBJ having already been stored in the containing box CB is photographed and recognized by the photographing device CAM2 installed on the arm at the timing of grasping the objects OBJ. Since the quantity of the objects OBJ to be stored in the containing box CB, that is, quantity qy per box, has been determined beforehand, the degree of attainment of the quantity qn of the objects having been stored with respect to the quantity qy per box is monitored and recognized. The detected and recognized data and information are transmitted to the PLC (see FIG. 2). The PLC collects and then processes the data and information, thereby controlling and adjusting the behaviors of various means and apparatus, such as the robot hand 1000 and the expanding pawl portions 26.

FIG. 11D depicts a state in which the robot hand 1000 grasps a first one of the two objects OBJ placed on the expanding pawl portions 26, the slider 27 is moved to the position just under the hand 40a at the timing when the hand 40a and the arm 40b are raised upward, and the robot hand starts the operation for grasping a second object OBJ. Hence, the throughput of the box packing work for the objects OBJ placed on the expanding pawl portions 26 is raised.

FIG. 11E depicts a state in which the robot hand 1000 grasps the second object OBJ and the slider 27 to which the expanding pawl portions 26 are fixed is slid on the rail 28 and is returned to the side of the loading apparatus 1 at the timing when the hand 40a and the arm 40b are raised upward. At the loading apparatus 1, the objects OBJ to be transferred next are placed on the expanding pawl portions 26. The objects OBJ newly grasped by the loading apparatus 1 are also transferred to the side of the robot hand 1000 as depicted in FIG. 11A.

The operations depicted in FIGS. 11A to 11E are repeated until the quantity qn of the objects OBJ in the containing box CB reaches the quantity qy per box.

FIG. 11F depicts a state in which the operations depicted in FIGS. 11A to 11E have been repeated and the predetermined box packing work is completed. The photographing device CAM2 recognizes whether the predetermined quantity qy per box has been stored in the containing box CB in a predetermined arrangement. FIG. 11F depicts a state in which the quantity qy=15 has been stored in the predetermined arrangement. At the time when it is confirmed that the predetermined conditions have been satisfied, the containing box CB is carried out to the containing box carrying-out apparatus 5 located at the latter stage.

FIG. 12 is a schematic external view depicting the robot hand 1000 for use in the transfer apparatus 4. The components having the same functions as those of the components of the robot hand 1000A are designated by the same reference numerals and signs. The robot hand 1000A has a finger mechanism 100, an antebrachial bone 200, tendons 300, artificial muscles 400, flanges 500 and 510, solenoid valves 600 and the control board 700, thereby constituting the above-mentioned hand 40a. In this embodiment, the finger mechanism 100 has two fingers (a first finger 101 and a second finger 102). The first finger 101 and the second finger 102 are configured so as to extend or flex depending on the tensions of the tendons 300 that are extended or contracted by the artificial muscles 400. In this embodiment, as one of features, joint angles and forces are autonomously controlled by performing antagonistic control of two kinds of tendons 300 in order to achieve control (compliance control) for the form of grasping, holding force, the flexibility of finger joints, etc. In the case that it is not necessary to distinguish between the first finger 101 and the second finger 102 in the following description, each of these fingers is simply referred to as a finger (or a finger portion).

The artificial muscles 400 are disposed around the antebrachial bone 200. The antebrachial bone 200 corresponds to the antebrachial bone of a human being and is a member corresponding to the portion ranging from the wrist joint to the arm joint. The flanges 500 and 510 are provided at the proximal side end portion and the distal side end portion of the antebrachial bone 200, respectively. The artificial muscle 400 is, for example, a Mckibben air-driven actuator, and the contraction degree of the muscle is controlled by air supplied from a manifold 650 controlled by the opening/closing operations of the solenoid valve 600. In other words, in the case that air is supplied to the inside of the artificial muscle 400 (pressurizing control), the artificial muscle 400 expands in its lateral direction and shrinks in its longitudinal direction, whereby the muscle contracts. Conversely, in the case that air is released from the inside of the artificial muscle 400 (depressurizing control), the artificial muscle 400 shrinks in its lateral direction and extends in its longitudinal direction, whereby the muscle relaxes.

The solenoid valve 600 is controlled using a CPU mounted on the control board 700. An input side connector for use in various kinds of interfaces communicating with the CPU; an output side connector; coil drivers for driving the coils of the solenoid valves 600; and various kinds of electronic devices including operational amplifiers, comparators, transistors, diodes and resistors for processing various kinds of signals, voltages and currents may be mounted on the control board 700.

The distal side end portion of the artificial muscle 400 is connected to the tendon 300, and the proximal side end portion thereof is connected to a universal joint 502. The universal joint 502 is configured so as to freely slide inside a rib 501 provided in a demarcated region of a flange 500. The tendon 300 connected to the artificial muscle 400 is lengthened by the contraction of the artificial muscle 400 and is shortened by the relaxation of the artificial muscle 400.

In this embodiment, although the Mckibben air-driven actuator is used as the artificial muscle 400, a system for winding the tendon 300 using a motor and a pulley may be adopted instead of the air-driven actuator. Furthermore, it may be possible to adopt a system for directly expanding and contracting the tendon 300 using a linear motor or a system for expanding and contracting the tendon 300 using BioMetal formed of a fibrous actuator that is expanded and contracted by the flow of electric current.

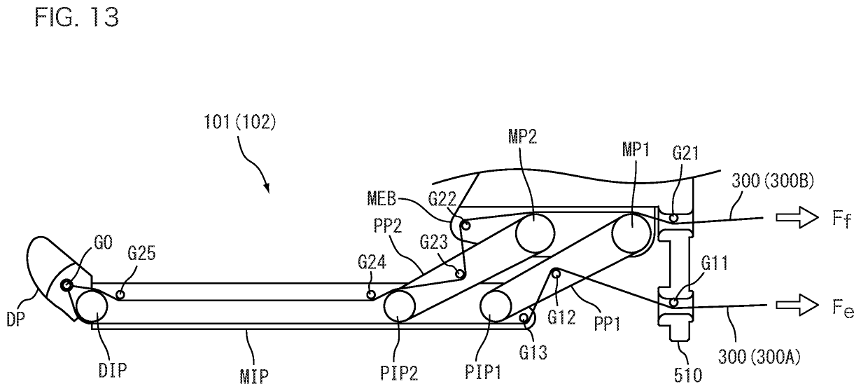

FIG. 13 is an external view depicting the finger mechanism 100. The finger mechanism 100 according to this embodiment has the first finger 101 (for example, thumb) and the second finger 102 (for example, index finger). Each of the fingers 101 and 102 is equipped with a metacarpal bone MEB, two proximal phalanxes PP1 and PP2, a middle phalanx MIP, and a distal phalanx DP in this order from the proximal side. These bone members are made of, for example, acrylonitrile-butadiene-styrene copolymerized resin (ABS resin).

The metacarpal bone MEB is fixed to the distal side end portion of the antebrachial bone 200. The proximal phalanx PP1 is disposed on the proximal side of the proximal phalanx PP2, and one end thereof is rotatably coupled to the metacarpal bone MEB and the other end thereof is rotatably coupled to the middle phalanx MIP. The turning core on the metacarpal bone MEB side of the proximal phalanx PP1 constitutes a metacarpophalangeal joint MP1. A part of the cross-sectional shape of the metacarpophalangeal joint MP1 has a curved surface portion formed into a circular or elliptical shape and is integrated with, for example, the proximal phalanx PP1. Furthermore, the turning core on the middle phalanx MIP side of the proximal phalanx PP1 constitutes a proximal interphalangeal joint PIP1. A part of the cross-sectional shape of the proximal interphalangeal joint PIP1 has a curved surface portion formed into a circular or elliptical shape and is integrated with, for example, the proximal phalanx PP1.

The proximal phalanx PP2 is disposed on the distal side of the proximal phalanx PP1, and one end thereof is rotatably coupled to the metacarpal bone MEB and the other end thereof is rotatably coupled to the middle phalanx MIP. The turning core on the metacarpal bone MEB side of the proximal phalanx PP2 constitutes a metacarpophalangeal joint MP2. A part of the cross-sectional shape of the metacarpophalangeal joint MP2 has a curved surface portion formed into a circular or elliptical shape and is integrated with, for example, the proximal phalanx PP2. Furthermore, the turning core on the middle phalanx MIP side of the proximal phalanx PP2 constitutes a proximal interphalangeal joint PIP2. A part of the cross-sectional shape of the proximal interphalangeal joint PIP2 has a curved surface portion formed into a circular or elliptical shape and is integrated with, for example, the proximal phalanx PP2.

The two proximal phalanxes PP1 and PP2 have approximately the same length and form a parallel link mechanism between the metacarpal bone MEB and the middle phalanx MIP. Hence, in the case that the proximal phalanxes PP1 and PP2 have turned to the proximal side with respect to the metacarpal bone MEB, the middle phalanx MIP is displaced to the proximal side and to the outside (the back side of the hand) while the posture thereof remains unchanged. Furthermore, in the case that the proximal phalanxes PP1 and PP2 have turned to the distal side with respect to the metacarpal bone MEB, the middle phalanx MIP is displaced to the distal side and to the inside (the palm side of the hand) while the posture thereof remains unchanged.

The distal phalanx DP is a bone member, the longitudinal dimension of which is shorter than that of the middle phalanx MIP, and the distal phalanx DP is rotatably coupled to the distal side end portion of the middle phalanx MIP. The turning core of the distal phalanx DP constitutes a distal interphalangeal joint DIP. A part of the cross-sectional shape of the distal interphalangeal joint DIP has a curved surface portion formed into a circular or elliptical shape and is integrated with, for example, the middle phalanx MIP.

Each of the fingers 101 and 102 is provided with the two tendons 300 and 300. One of the two tendons 300 and 300 is an extensor tendon 300A. The extensor tendon 300A is pulled by a pulling force Fe. The extensor tendon 300A extending from an extensor 400A serving as one of the artificial muscles 400 is guided by a tendon guide G11 provided inside a through hole passing through the rib 501 and is extended to the proximal phalanx PP1. The extensor tendon 300A is further guided by the tendon guide G12 provided in the middle of the proximal phalanx PP1 and the tendon guide G13 provided at the proximal side end portion of the middle phalanx MIP, thereby being disposed on the outside (the back side of the hand) of the middle phalanx MIP. Furthermore, while making contact with the curved surface portions of the proximal interphalangeal joints PIP1 and PIP2 and the distal interphalangeal joint DIP, the extensor tendon 300A is extended in the longitudinal direction of the middle phalanx MIP to the distal phalanx DP.

The distal side end portion of the extensor tendon 300A is fixed to the fixing end GO provided in the distal phalanx DP. Since the fixing portion between the extensor tendon 300A and the distal phalanx DP is subjected to a tensile stress, it is concerned that the mechanical strength thereof may be deteriorated. For the purpose of eliminating such deterioration in the mechanical strength, for example, the extensor tendon 300A may be installed by connecting the extensor tendon 300A to a part of the distal phalanx DP so that the stress can be relieved, without completely fastening them with each other.

The other of the two tendons 300 and 300 is a flexor tendon 300B. The flexor tendon 300B is pulled by a pulling force Ff. The flexor tendon 300B extending from a flexor 400B serving as one of the artificial muscles 400 is guided by a tendon guide G21 provided inside another through hole passing through the rib 501 and by a tendon guide G22 provided in the metacarpal bone MEB and is extended to the proximal phalanx PP2 while making contact with the curved surface portions of the proximal interphalangeal joints PIP1 and PIP2. The flexor tendon 300B is further guided by a tendon guide G23 provided in the middle of the proximal phalanx PP2 and by two tendon guides G24 and G25 provided in the middle phalanx MIP, thereby being disposed on the inside (the palm side of the hand). Furthermore, while making contact with the curved surface portions of the proximal interphalangeal joint PIP2 and the distal interphalangeal joint DIP, the flexor tendon 300B is extended in the longitudinal direction of the middle phalanx MIP to the distal phalanx DP.

The distal side end portion of the flexor tendon 300B is fixed to the fixing end GO provided in the distal phalanx DP. Since the fixing portion between the flexor tendon 300B and the distal phalanx DP is subjected to a tensile stress, it is concerned that the mechanical strength thereof may be deteriorated. For the purpose of the eliminating such deterioration in the mechanical strength, for example, the flexor tendon 300B may be installed by connecting the flexor tendon 300B to a part of the distal phalanx DP so that the stress can be relieved, without completely fastening them with each other.

Although the finger mechanism 100 according to this embodiment is equipped with the first finger 101 (for example, thumb) and the second finger 102 (for example, index finger), the finger mechanism may be further equipped with at least one of a third finger (for example, middle finger), a fourth finger (for example, ring finger) and a fifth finger (for example, little finger), thereby being equipped with three or more finger portions. Moreover, the finger mechanism 100 according to this embodiment may be equipped with the same two or more finger portions corresponding to the first finger 101 or the second finger 102.

What's more, in at least one of the distal phalanx DP and the middle phalanx MIP, the portion thereof (that is, the palm side of the hand) making contact with an object OBJ to be grasped may be provided with a force sensor for detecting the holding force exerted at the time when the finger mechanism 100 holds the object OBJ. Still further, each joint portion may be provided with an angle sensor for detecting the angle (joint angle) between the members coupled to each other. The force sensor and the angle sensor described above are not essentially required for the finger mechanism 100 according to the present invention. However, in the case that the shape and the hardness of the object OBJ are known beforehand, the movement ranges of the respective finger portions can be controlled automatically by installing these sensors.

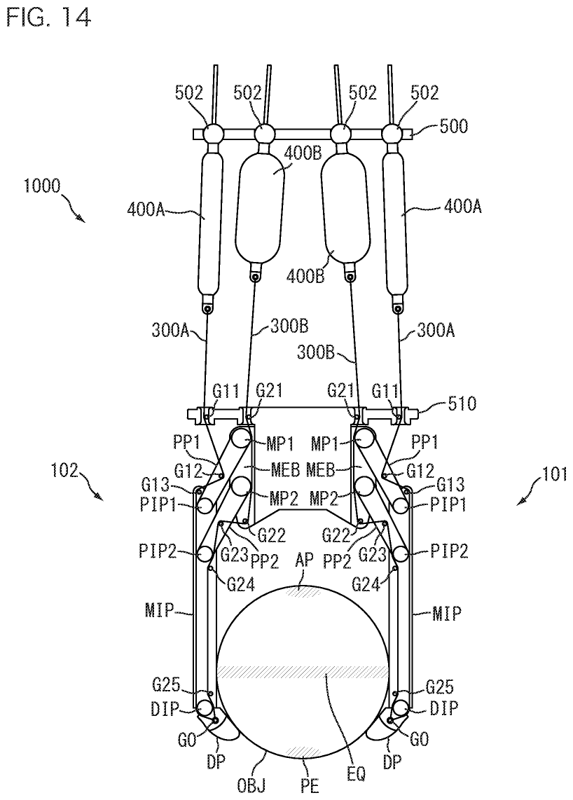

FIG. 14 is a schematic explanatory view depicting a state in which the object OBJ is grasped with the finger mechanism 100 depicted in FIG. 13. In this embodiment, when the object OBJ is grasped, the flexors 400B are controlled in a pressurized state. At this time, the flexors 400B are expanded in the lateral direction and shrunk in the longitudinal direction, thereby pulling the flexor tendons 300B. By the pulling forces Ff of the flexor tendons 300B, the distal phalanxes DP at the fingertips are flexed with respect to the middle phalanxes MIP, and both the proximal phalanxes PP1 and PP2 of the first finger 101 and the second finger 102 are turned to the distal side. As the proximal phalanxes PP1 and PP2 are turned, the middle phalanxes MIP of the fingers 101 and 102 are displaced to the distal side and to the inside (the palm side of the hand). Hence, the middle phalanxes MIP and MIP of the two fingers 101 and 102 are extended to the sides of the fingertips while maintaining a nearly parallel state therebetween, whereby the distance between the middle phalanxes MIP and MIP is reduced. With this operation, the fingers 101 and 102 can grasp the object OBJ.

In the case that the object OBJ to be grasped with the finger mechanism 100 depicted in FIG. 14 is a peach, the peach has a fruit peduncle (fruit stem) portion PE and a fruit apex portion AP. Although the terms “fruit peduncle (fruit stem) portion” and “fruit apex portion” are referred to differently depending on the type of fruit/vegetable, the opposite side of the fruit peduncle (fruit stem) portion is referred to as the fruit apex portion regardless of the type of fruit/vegetable in this document for convenience of explanation. Furthermore, in this document, the height from the fruit peduncle (fruit stem) portion PE to the fruit apex portion AP of a fruit/vegetable is referred to as a vertical diameter, the width of the fruit/vegetable orthogonal to the vertical diameter is referred to as a horizontal diameter, and the portion in the vicinity of the portion having the largest horizontal diameter is referred to as the equatorial portion of the fruit/vegetable.

FIG. 14 depicts a state in which the fingers 101 and 102 of the finger mechanism 100 according to the embodiment of the present invention grasp the outer circumferential face of the equatorial portion EQ of the object OBJ from the side of the fruit apex portion AP. Unlike a peach, fruits such as an apple, a pear and a melon are generally placed so that the side of the fruit peduncle portion thereof is directed upward in many cases. Hence, at the time of grasping this kind of fruit/vegetable, the fingers 101 and 102 move downward from the fruit peduncle portion toward the equatorial portion EQ and grasps the outer circumferential face ranging from the equatorial portion EQ to the vicinity of the fruit peduncle portion.

The configuration of the finger mechanism 100 depicted in FIG. 14 is summarized as described below. The finger mechanism 100 is equipped with the metacarpal bones MEB serving as base portions and the plurality of finger portions (the first finger 101 and the second finger 102) supported by the metacarpal bones MEB. Each of the first finger 101 and the second finger 102 is equipped with a first bone member (the middle phalanx MIP) and a second bone member (the distal phalanx DP) rotatably coupled to one end portion of the middle phalanx MIP and is further equipped with a pair of third bone members (the proximal phalanxes PP1 and PP2), each of which is rotatably coupled to the other end portion of the first bone member (the middle phalanx MIP) and the metacarpal bone MEB, whereby a parallel link mechanism is formed between the middle phalanx MIP and the metacarpal bone MEB. Furthermore, FIG. 14 depicts a state in which the first finger 101 and the second finger 102 grasp the outer circumferential face of the equatorial portion EQ of a spherical fruit/vegetable (the object OBJ).

Moreover, the configuration of the finger mechanism 100 depicted in FIG. 14 is summarized as described below. The finger mechanism is equipped with the extensor tendon 300A disposed on the side in which the second bone member (the distal phalanx DP) of each of the fingers 101 and 102 extends with respect to the first bone member (the middle phalanx MIP) and extending along one side of each of the second bone member (the distal phalanx DP), the first bone member (the middle phalanx MIP) and the pair of third bone members (the proximal phalanxes PP1 and PP2); the extensor 400A connected to the extensor tendon 300A and used to expand and contract the extensor tendon 300A; the flexor tendon 300B disposed on the side in which the second (the distal phalanx DP) flexes with respect to the first bone member (the middle phalanx MIP) and extending along the other side of each of the second bone member (the distal phalanx DP), the first bone member (the middle phalanx MIP) and the pair of third bone members (proximal phalanxes PP1 and PP2); and the flexor 400B connected to the flexor tendon 300B and used to expand and contract the flexor tendon 300B.

FIGS. 15A to 15E depict a transition state in which the robot hand 1000 receives the object OBJ from the expanding pawl portion 26. FIGS. 15A to 15E depict the transfer of the object OBJ between the expanding pawl portion 26 and the robot hand 1000 in more detail than that depicted in FIG. 8E. Although FIGS. 15A to 15E depict only one expanding pawl portion 26, two expanding pawl portions 26 are provided in the embodiment according to the present invention, for example, as depicted in FIG. 1. In FIGS. 15A to 15E, the same components as those depicted in FIGS. 5A to 5G are designated by the same reference numerals and signs.

FIG. 15A depicts a state in which the object OBJ has been grasped with the expanding pawl portion 26 having six pawls 26a to 26f and the robot hand 1000 stands by at the standby position thereof. The shape of the expanding pawl portion 26 has been selected so as to receive a spherical object OBJ without causing trouble, more specifically, in consideration of the structure of the expanding pawl portion 26 in which the planar shape of the expanding pawl portion 26 is formed into a nearly circular shape in order to expand the protection cap 22, and the expanding pawl portion 26 does not make contact with the hand 40a having two or four fingers of the robot hand 1000 during box packing. The six pawls arranged in a regular hexagonal shape, having been selected in this way, are installed on a pawl holding block 26s. The robot hand 1000 has the finger mechanism 100 equipped with, for example, two pairs of fingers (that is to say, a pair of the first finger 101 and the second finger 102 and a pair of a first finger 101a and a second finger 102a). At the time of this standby state, the spatula-shaped pawls 26a to 26f are placed away from the finger mechanism 100 with the object OBJ placed therebetween, whereby they do not make contact with each other.

FIG. 15B depicts a state in which the robot hand 1000 has moved downward to the grasping position of the object OBJ and the first finger 101 and the second finger 102 (the first finger 101a and the second finger 102a) are approaching the wide portions of the spatula-shaped pawls. At this time, the first finger 101 and the second finger 102 (the first finger 101a and the second finger 102a) move downward so as to be positioned in the space surrounded by the six pawls 26a to 26f.

FIG. 15C depicts a state in which one pair of the first finger 101 and the second finger 102 (or one pair of the first finger 101a and the second finger 102a) of the two pairs of fingers of the finger mechanism has grasped the object OBJ and stands by for the upward lifting of the object OBJ. At this time, the other pair of the first finger 101a and the second finger 102a (or the other pair of the first finger 101 and the second finger 102) is not in the state of grasping the object OBJ.

FIG. 15D depicts a state in which the robot hand 1000 has slightly moved upward from the state depicted in FIG. 15C while grasping the object OBJ with one pair of the first finger 101 and the second finger 102 (or one pair of the first finger 101a and the second finger 102a). At this time, the other pair of the first finger 101a and the second finger 102a (or the one pair of the first finger 101 and the second finger 102) is in the same state as that depicted in FIG. 15C.

FIG. 15E depicts a state in which the robot hand 1000 grasps the object OBJ with the two pairs fingers (one pair of the first finger 101 and the second finger 102 and the other pair of the first finger 101a and the second finger 102a) and moves upward away from the pawls 26a to 26f of the expanding pawl portion 26. In other words, in the state depicted in FIG. 15E, the other pair of the first finger 101a and the second finger 102a starts the grasping operation for the first time. Hence, the force for grasping the object OBJ is enhanced, and the object OBJ can be box-packed in a stable state.

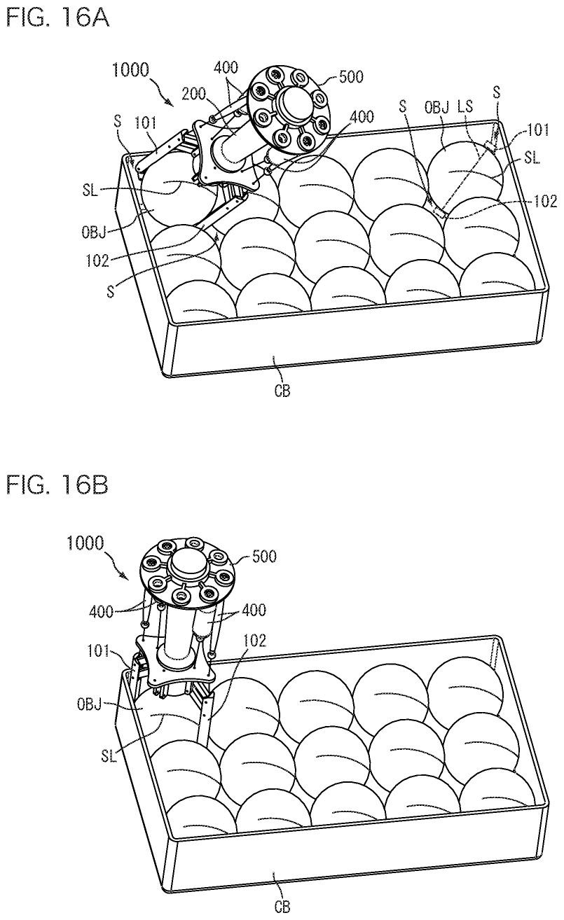

FIGS. 16A and 16B are schematic perspective views illustrating a rolling storage method according to the present invention. For convenience of explanation, an example is depicted in which 5×3=15 peaches (quantity qy per box) serving as the objects OBJ are stored in the containing box CB. The rolling storage method according to the present invention is an effective storage method regardless of the difference in the quantity qy per box. The rolling storage method is not available universally but has been devised by the inventor of the present invention as a result of many trials in which spherical objects were grasped and box-packed. The rolling storage method is a method in which an object is stored while the object rolls on the circumferences of the objects having already been stored without sliding therearound. In addition to the description of the rolling storage method referring to FIGS. 16A and 16B, the rolling storage method in the case that the space for storage is particularly limited will further be described in more detail referring to figures described later. Hence, a conceptual description is given referring to FIGS. 16A and 16B.

FIG. 16A depicts a state in which the box packing of the objects OBJ in the containing box CB using the robot hand 1000 is performed, 14 objects of all the 15 objects to be box-packed have already been stored, and the storage of the last object according to the rolling storage method has started. At the start time of the rolling storage, the robot hand 1000 is inclined at a predetermined angle with respect to the bottom portion of the containing box CB. The inclination angle is determined by considering that the first finger 101 and the second finger 102 can enter the spaces s generated between the corner portion of the containing box CB and the objects OBJ having already been stored and that the first finger 101 and the second finger 102 do not make contact with the objects OBJ located therearound. In the case that the suture line SL of the peach is aligned with, for example, the longitudinal direction of the containing box CB, the portions of the first finger 101 and the second finger 102 must be avoided from overlapping with the suture line SL. Furthermore, the line segment LS depicted in FIG. 16A must be avoided from having a positional relationship in which the line segment becomes orthogonal to the direction of the suture line SL. More specifically, when it is assumed that the suture line of the peach is SL and that the line segment connecting the positions where the first finger 101 and the second finger 102 grasp the fruit/vegetable (objects OBJ) is LS, the line segment LS is preferably inclined in a range of 30 (210) to 60 (240) degrees with respect to the direction of the suture line SL. A range of 40 (220) to 50 (230) degrees is further preferable. With this positional relationship, the first finger 101 and the second finger 102 can sufficiently enter the spaces s, and box packing can be achieved while the directions of the suture lines SL of all the peaches to be box-packed are aligned. Even in the case that the rolling storage method is not adopted, the positional relationship between the line segment LS and the suture line SL is the same as the above-mentioned positional relationship.

FIG. 16B depicts a state at the time when the box packing work is ended in the case that the rolling storage method is adopted and in the case that the rolling storage method is not adopted. When the robot hand 1000 is turned to the direction orthogonal to the bottom portion of the containing box CB, the 15th object OBJ to be stored last can be stored smoothly in a corner portion of the containing box CB.

Although the robot hand 1000 equipped with the first finger 101 and the second finger 102 is depicted in FIGS. 16A and 16B, the robot hand 1000 may be equipped with two more fingers (the first finger 101a and the second finger 102a).

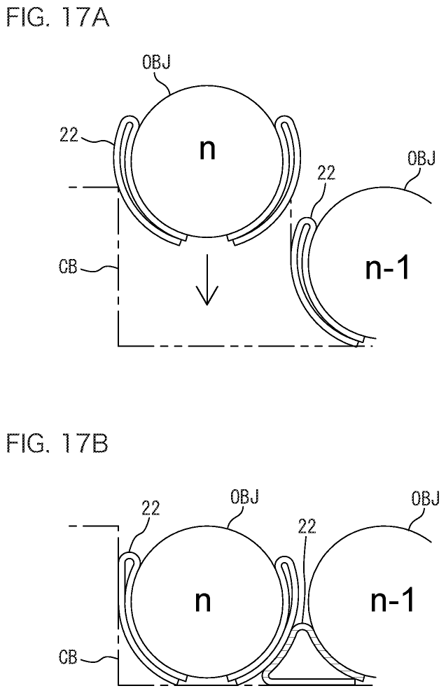

FIGS. 17A and 17B are explanatory views illustrating undesirable states that occur at the time when an object OBJ covered with the protection cap 22 is stored in a corner of the containing box CB using the robot hand 1000 depicted in FIG. 12. Furthermore, the descriptions referring to FIGS. 16A and 16B can also be applied to the descriptions referring to FIGS. 17A and 17B. For example, the grasping operation of grasping the object OBJ with the first finger 101 and the second finger 102, the positional relationship between the grasping positions and the suture line SL, and the storage procedure for storing the object OBJ in the containing box CB, depicted in FIGS. 16A and 16B but not depicted in FIGS. 17A and 17B, are almost the same in the states depicted in FIGS. 17A and 17B. Hence, FIGS. 17A and 17B are used to describe undesirable states in the case that the object OBJ is covered with the protection cap 22.

FIG. 17A depicts a state in which the (n−1)th object OBJ has been stored in the containing box CB and the nth object OBJ is being stored into the space formed between the (n−1)th object OBJ and the containing box CB. FIG. 17B depicts a state in which the storage of the nth object OBJ is completed. The protection cap 22 has a structure, for example, in which a tubular elastic member is folded back at the central portion thereof, and the object OBJ is pushed from the folding-back direction, whereby the protection cap 22 is attached to the object OBJ. Hence, in the case that a force is applied from above to the folded-back portion, a problem occurs in which the protection cap 22 is detached easily as depicted in FIG. 17B.

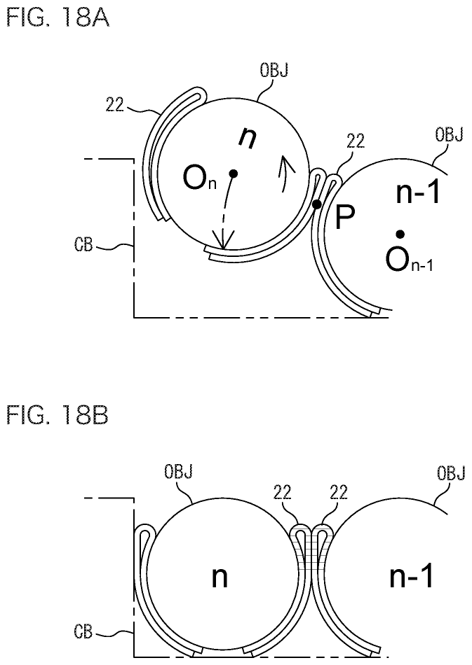

FIGS. 18A and 18B depict an example in which the rolling storage method according to the present invention is used to eliminate the problem depicted in FIGS. 17A and 17B. FIG. 18A depicts a state in which the (n−1)th object OBJ has been stored in the containing box CB and the nth object OBJ is being stored into the space formed between the (n−1)th object OBJ and the containing box CB. FIG. 18B depicts a state in which the storage of the nth object OBJ is completed. In this embodiment, when the nth object OBJ is stored into the above-mentioned space, the nth object OBJ is stored while rolling on the circumference of the (n−1)th object OBJ (rolling storage) without sliding therearound, whereby the protection cap 22 can be prevented from being detached.

Moreover, after the storage of the object OBJ is completed, in the case that the first finger 101 and the second finger 102 of the robot hand 1000 are released and the fingertips thereof are opened at the time when the fingers are moved away from the object OBJ, the robot hand 1000 may cause interference, friction or the like with the protection cap 22 and the containing box CB, whereby the protection cap 22 may be displaced and the stored object OBJ may be lifted. However, in the robot hand 1000 according to this embodiment, the first finger 101 and the second finger 102 can be moved away from the object OBJ without opening the fingertips thereof. Hence, when the first finger 101 and the second finger 102 are removed from the containing box, the protection cap 22 can be prevented from being displaced and the stored object OBJ can be prevented from being lifted

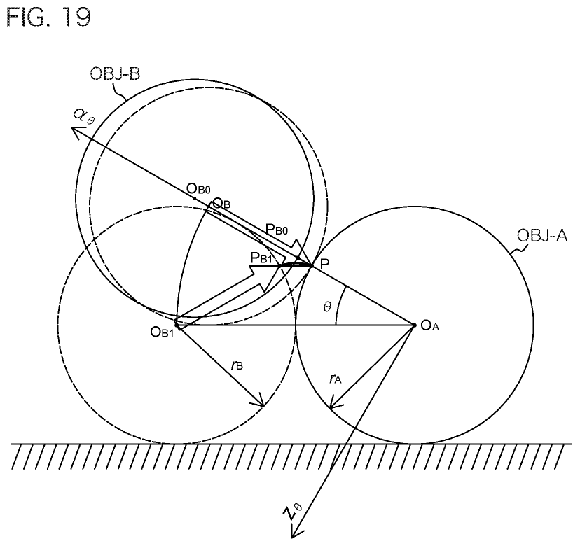

FIG. 19 is an explanatory view illustrating the mechanism of the rolling storage. FIG. 19 depicts a state in which an object OBJ-A has been stored and another OBJ-B is being stored while making close contact with the object OBJ-A. In FIG. 19, both the objects OBJ-A and OBJ-B attached with the protection caps 22 and having a circular shape are depicted, for the sake of simplicity. As depicted in FIG. 19, in the case that the object-B making made contact with the object OBJ-A at point P is rolled along the circumference of the object OBJ-A, no slippage occurs at the protection cap 22 and the protection cap 22 is not detached.

In the case that the object OBJ-A is represented by a fixed circle with position O_{A} as a center and that the objects OBJ-B is represented by a moving circle with position O_{B} as a center, the object OBJ-B moves along the locus depicted in FIG. 19. More specifically, when the object-B making contact with the object OBJ-A at the point P is rolled on the circumference of the object OBJ-A without slippage, the point P on the object OBJ-B is moved to point P_{B1} and the locus becomes an epicycloid curve. In the case that the radius of the circle representing the object OBJ-A is r_{A} and the radius of the circle representing the object OBJ-B is r_{B}, the following relational expressions are obtained.

a_{θ}=(r_{A}+r_{B})cos θ·r_{B} cos((r_{A}+r_{B})/r_{B})θ

Z_{θ}=(r_{A}+r_{B})sin θ−r_{B} sin((r_{A}+r_{B})/r_{B})θ

The coordinates obtained by the above-mentioned relational expressions are incorporated in coordinate calculations for the control of the robot hand 1000, and control for moving a vector O_{B}-P to a vector O_{B1}-P_{B1} is performed, whereby rolling storage can be achieved. The vector O_{B}-P is referred to as a rolling vector and r_{B} is referred to as a rolling radius.

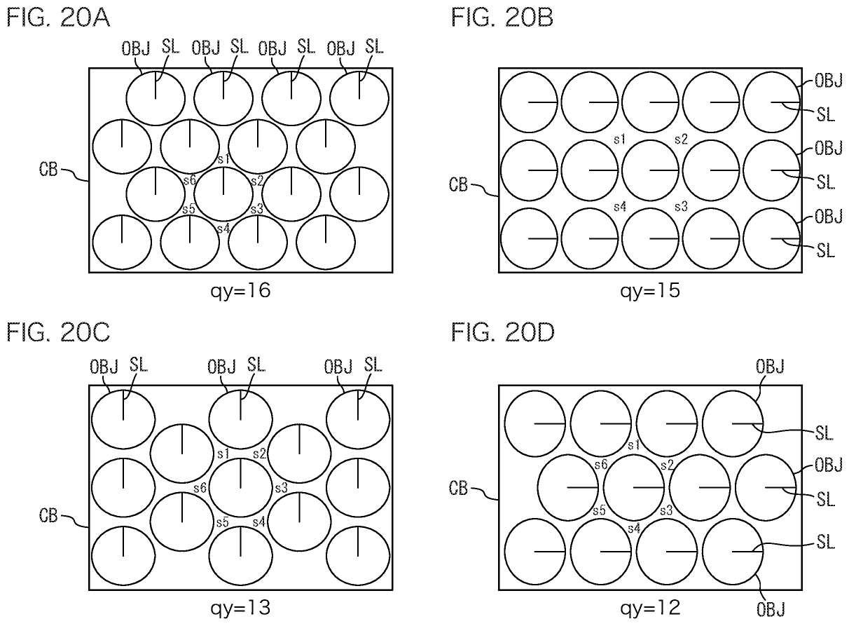

FIGS. 20A to 20D are explanatory views illustrating storage states. FIG. 20A depicts a state in which 16 objects OBJ (quantity qy=16) are stored in a containing box having a rectangular parallelepiped shape while being made close contact with one another. In the state in which the storage of the objects OBJ is completed, in the case that an object OBJ is surrounded by the other objects OBJ, six spaces designated by signs sl to s6 are generated. Furthermore, in the case that an object is adjacent to the wall side of the containing box, for example, three or four spaces are generated.

Similarly, FIGS. 20B to 20D depict states in which 15 objects OBJ (quantity qy=15), 13 objects OBJ (quantity qy=13) and 12 objects OBJ (quantity qy=12) are respectively stored in containing boxes having a rectangular parallelepiped shape while being made close contact with one another. It is found that four to six spaces are generated around an object OBJ.

The robot hand 1000 grasps the portions of an object OBJ corresponding to the spaces using the first finger 101 and the second finger 102, moves the object OBJ to the storage position and pushes the object OBJ and then releases and moves the first finger 101 and the second finger 102 away from the object OBJ, whereby the object OBJ is stored while being made close contact with the other objects having been stored.

The robot hand 1000 according to this embodiment can grasp an object OBJ without opening the fingertips thereof and can release the grasped object OBJ without opening the fingertips. Hence, in the case that spaces have been generated between objects OBJ or between an object OBJ and an wall side of the containing box CB as depicted in FIGS. 20A to 20D, the robot hand 1000 grasps the portions of the object OBJ corresponding to the spaces and moves the object OBJ into the containing box CB, whereby the object OBJ can be stored while being made close contact with the other objects having been stored.

However, in the case that objects, such as fruits serving as the objects OBJ, are covered with the protection caps 22, when the objects OBJ are stored while being made close contact with one another, the protection caps 22 attached to the objects OBJ being adjacent to each other are detached easily. Hence, this problem must be overcome.

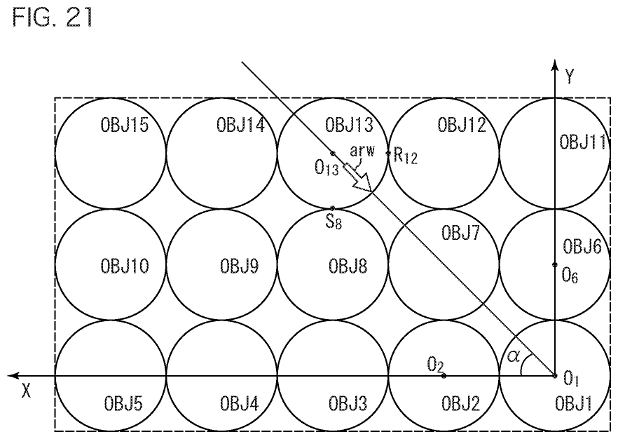

FIG. 21 is an explanatory view illustrating a sequence for storing, for example, 15 objects OBJ (quantity qy=15), in the containing box CB. When 15 objects OBJ1 to OBJ15 are stored in the containing box CB, a procedure in which the objects are stored in the sequence of the objects OBJ1, OBJ2, OBJ3, . . . , OBJ5 is assumed to be used. When the object OBJ1 is stored in the containing box, the other objects OBJ2 to OBJ15 do not exist in the containing box and the object OBJ1 can secure a sufficient space. In this case, the rolling storage is not applied, but, for example, the robot hand 1000 is moved translationally inside the containing box in the direction indicated by a void arrow arw depicted in the figure, whereby the object OBJ1 can be stored at a predetermined storage position. The objects OBJ2 to OBJ4 and OBJ6 to OBJ9 can also be stored similarly at predetermined storage positions by only the translational movement of the robot hand 1000.

On the other hand, in the case that the objects OBJ5 and OBJ10 to OBJ15 are stored in the containing box CB, a sufficient space for the translational movement cannot be secured, and the rolling storage is required. For example, in a state in which, for example, the objects OBJ1 to OBJ12 have been stored and the object OBJ13 is further stored, the object OBJ13 is moved in the direction indicated by the void arrow arw depicted in the figure, and the rolling storage is performed while the object OBJ13 is made contact with the objects OBJ8 and OBJ12 at contact points S8 and R12, respectively. In the case that the line segment connecting the center O₁ of the object OBJ1 to the center O₂ of the object OBJ2 on a horizontal plane is assumed to be an X-axis and that the line segment connecting the center O₁ of the object OBJ1 to the center O₆ of the object OBJ6 on a horizontal plane is assumed to be a Y-axis, the axis being orthogonal to the X-axis and the Y-axis is a Z-axis, the line segment connecting the center O₁ of the object OBJ1 to the center O₁₃ of the object OBJ13 on a horizontal plane is an α-axis, and the angle formed between the X-axis and the α-axis is α that is used in the above-mentioned expression.

The objects OBJ11, OBJ12, OBJ14 and OBJ15 are stored in the containing box in a similar way. Each of these objects OBJ is stored according to the rolling storage method while making contact with the other objects having been stored at two (or one) points, whereby each of the objects can be stored in the containing box while the protection cap 22 is prevented from being detached.

The fruit/vegetable transfer system 10 described above can be replaced with several fruit/vegetable transfer systems being different in configuration. For example, in the case of a system in which the chute track 62 depicted in FIG. 2 is extended to the side of the transfer apparatus 4 so that the objects OBJ can be directly carried out the transfer apparatus 4 from the side of the inspection apparatus 6, the system can be applied to a configuration in which the protection caps 22 are not attached to the objects. Furthermore, the same type of robot hand as the robot hand 1000 being used to transfer the objects OBJ to the containing box CB may be adopted for the loading apparatus 1. Moreover, in the case that the transfer apparatus 4 is limited to the type dealing with objects to which the protection caps 22 are not attached, the loading apparatus 1, the protection cap attaching apparatus 2, the expanding pawl portions 26, etc. are not required to be prepared, whereby the entire system can be simplified.

What's more, although the transfer apparatus according to the present invention is assumed to be used to mainly transfer spherical fruits/vegetables, the transfer apparatus can also be applied to the grasping of fruits, such as strawberries, lemons, grapes and bananas, and vegetables, such as cucumbers, eggplants and pumpkins. Still further, the transfer apparatus can also be applied to the grasping of foods and foodstuffs, such as sandwiches and breads having triangular and square shapes, without being limited to fruits/vegetables. Yet still further, although a corrugated cardboard box is taken as an example of the containing box, boxes made of plastic and wood, for example, may also be used.

It is assumed that the embodiments having been disclosed this time are merely examples in all respects and not to be understood as limiting. The scope of the present invention is not defined by the above description, but by the appended claims, and includes all the changes within the meanings and ranges equivalent to the

What is claimed is:

1. A transfer apparatus comprising:
a finger mechanism configured to grasp an outer circumferential face of an object, wherein
the finger mechanism is equipped with a plurality of finger portions supported by a base portion,
each of the finger portions includes:
a first bone member;
a second bone member rotatably coupled to one end portion of the first bone member; and
a pair of third bone members, each of which is rotatably coupled to the other end portion of the first bone member and the base portion, whereby a parallel link mechanism is formed between the first bone member and the base portion; and
the finger mechanism transfers the grasped object to a containing box.

2. The transfer apparatus according to claim 1, wherein the finger mechanism includes:
an extensor tendon disposed on a side in which the second bone member extends with respect to the first bone member and extending along the second bone member, the first bone member and one of the pair of third bone members;
an extensor connected to the extensor tendon and used to expand and contract the extensor tendon;
a flexor tendon disposed on a side in which the second bone member flexes with respect to the first bone member and extending along the second bone member, the first bone member and the other of the pair of third bone members; and
a flexor connected to the flexor tendon and used to expand and contract the flexor tendon.

3. The transfer apparatus according to claim 2, wherein
the extensor and the flexor are Mckibben air-driven actuators.

4. The transfer apparatus according to claim 3, further comprising:
a pressurizing solenoid valve and a decompressing solenoid valve provided midway on a supply path to supply compressed air to the Mckibben air-driven actuators; and
a controller that controls the opening/closing operations of the pressurizing solenoid valve and the decompressing solenoid valve, wherein
the controller adjusts the air pressures inside the air-driven actuators by controlling the opening/closing operations of the pressurizing solenoid valve and the decompressing solenoid valve, thereby controlling the contraction degrees of the extensor and the flexor of the finger mechanism.

5. The transfer apparatus according to claim 1, wherein
the object has a spherical shape, and
when the finger mechanism stores the grasped object with the finger portions in a space between objects having already been stored in the containing box and an inner wall of the containing box, the finger mechanism moves the grasped object so that the grasped object rolls on a circumference of the stored object.

6. The transfer apparatus according to claim 5, wherein
the finger mechanism moves the object so that the locus of a point on the grasped object becomes an epicycloid curve.

7. The transfer apparatus according to claim 6, wherein
the finger mechanism moves the object according to a number of the objects to be stored in the containing box, the positions of the objects in the containing box, and parameters that determines the locus.

8. The transfer apparatus according to claim 1, wherein the finger portion of the finger mechanism includes:
two finger portions, to be used when a placed object is lifted upward, configured to grasp the object; and
two finger portions different from the above-mentioned two finger portions, to be used after the object is lifted upward, configured to assist the grasping of the object with the above-mentioned two finger portions.

9. The transfer apparatus according to claim 1, wherein
the objects are peaches and the peaches are stored in the containing box while suture lines thereof are aligned in a same direction.

10. The transfer apparatus according to claim 9, wherein
the finger mechanism grasps, with at least two finger portions, an outer surface portion of the peach that is inclined in a range of 30 to 60 degrees (or 210 to 240 degrees) with respect to the direction of the suture line.

11. A transfer system comprising:
a containing box supplying apparatus configured to supply a containing box;
the transfer apparatus according to claim 1 configured to grasp an outer circumferential face of an object and to transfer the object to the containing box supplied from the containing box supplying apparatus; and
a containing box carrying-out apparatus configured to carry out the containing box in which the objects are stored.

12. The transfer system according to claim 11, further comprising:
a protection cap attaching apparatus equipped with a supplying unit that supply a protection cap for protecting an object and an expanding pawl portion to which the protection cap supplied from the supplying unit is attached; and
a loading apparatus configured to place the object into the protection cap attached to the expanding pawl portion and expanded.

13. The transfer system according to claim 12, wherein
the loading apparatus has a robot hand equipped with five finger portions imitating the hand of a human being, and
the robot hand grasps the object with the five finger portions, places the object in the protection cap and pushes the object placed inside the protection cap to the bottom portion of the expanding pawl portion using the hand portion of the robot hand.

14. The transfer system according to claim 13, wherein
each of the five finger portions is configured to extend or flex depending on a tension of a tendon that is expanded or contracted using artificial muscles, and
the artificial muscles are Mckibben type air actuators.

15. The transfer system according to claim 13, wherein
the robot hand is worn with a glove.
